(19) United States
(12) Patent Application Publication
(10) Pub. No.: US 2025/0384571 A1
(43) Pub. Date: Dec. 18, 2025

(54) INFORMATION PROCESSING APPARATUS, INFORMATION PROCESSING METHOD, AND NON-TRANSITORY COMPUTER READABLE RECORDING MEDIUM

(71) Applicant: NEC Corporation, Tokyo (JP)

(72) Inventors: Masahiro YAMAGUCHI, Tokyo (JP); Takashi SHIBATA, Tokyo (JP)

(73) Assignee: NEC Corporation, Tokyo (JP)

(21) Appl. No.: 19/229,163

(22) Filed: Jun. 5, 2025

(30) Foreign Application Priority Data
Jun. 18, 2024 (JP) 2024-098273

(51) Int. Cl. G06T 7/50

(52) U.S. Cl. CPC G06T 7/50; G06T 2207/10028; G06T 2207/10152; G06T 2207/20081

(57) ABSTRACT

Both local details and a global three-dimensional shape of an object in an image are suitably reconstructed. An information processing apparatus includes: an acquisition unit configured to acquire input data including a plurality of images under a plurality of illumination conditions; an estimation unit configured to execute normal estimation processing and depth estimation processing with reference to the input data; a priority determination unit configured to determine priorities of the normal estimation processing and the depth estimation processing; and a generation unit configured to generate output data with reference to a result of the normal estimation processing, a result of the depth estimation processing, and the priorities.

### INCORPORATION BY REFERENCE

This application is based upon and claims the benefit of priority from Japanese patent application No.2024-098273, filed on Jun. 18, 2024, the disclosure of which is incorporated herein in its entirety by reference.

### TECHNICAL FIELD

The present disclosure relates to an information processing apparatus, an information processing method, and a program.

### BACKGROUND ART

There is known a technique called Photometric Stereo that refers to a plurality of images captured under a plurality of illumination conditions to ascertain a shape of an object in the images (for example, S. Ikehara, Universal Photometric Stereo Network using Global Lighting Contexts, arXiv: 2206.02452v1, June 2022).

### SUMMARY

The technique described in S. Ikehara, Universal Photometric Stereo Network using Global Lighting Contexts, arXiv: 2206.02452v1, June 2022 is excellent in reconstructing a local detailed shape such as a surface texture of an object, but has a problem in terms of reconstructing a global three-dimensional shape of the object.

The present disclosure has been made in view of the above problem, and an exemplary object thereof is to provide an information processing apparatus, an information processing method, and a program capable of suitably reconstructing both local details and a global three-dimensional shape of an object in an image.

An information processing apparatus according to a first exemplary aspect of the present disclosure includes: an acquisition unit configured to acquire input data including a plurality of images under a plurality of illumination conditions; an estimation unit configured to execute normal estimation processing and depth estimation processing with reference to the input data; a priority determination unit configured to determine priorities of the normal estimation processing and the depth estimation processing; and a generation unit configured to generate output data with reference to a result of the normal estimation processing, a result of the depth estimation processing, and the priorities.

An information processing apparatus according to a second exemplary aspect of the present disclosure includes: an acquisition unit configured to acquire input data including a plurality of images under a plurality of illumination conditions; an estimation unit configured to execute normal estimation processing and depth estimation processing using an estimation model with reference to the input data; a priority determination unit configured to determine priorities of the normal estimation processing and the depth estimation processing; and a learning unit configured to train the estimation model using a loss function according to the result of the normal estimation processing, the result of the depth estimation processing, and the priorities.

An information processing method according to a third exemplary aspect of the present disclosure includes: acquiring input data including a plurality of images under a plurality of illumination conditions; executing normal estimation processing and depth estimation processing with reference to the input data; determining priorities of the normal estimation processing and the depth estimation processing; and generating output data with reference to a result of the normal estimation processing, a result of the depth estimation processing, and the priorities.

An information processing method according to a fourth exemplary aspect of the present disclosure includes: acquiring input data including a plurality of images under a plurality of illumination conditions; executing normal estimation processing and depth estimation processing using an estimation model with reference to the input data; determining priorities of the normal estimation processing and the depth estimation processing; and training the estimation model using a loss function according to the result of the normal estimation processing, the result of the depth estimation processing, and the priorities.

The information processing apparatus according to each aspect of the present disclosure may be implemented by a computer, and in this case, a program that causes the computer to operate as each unit (software element) included in the information processing apparatus to implement the information processing apparatus by the computer, and a computer-readable recording medium recording the program are also included in the scope of the present invention.

According to an exemplary aspect of the present disclosure, there is an exemplary effect that both local details and a global three-dimensional shape of an object can be suitably reconstructed.

### BRIEF DESCRIPTION OF DRAWINGS

The above and other aspects, features and advantages of the present disclosure will become more apparent from the following description of certain exemplary embodiments when taken in conjunction with the accompanying drawings, in which:

FIG. 1 is a block diagram illustrating a configuration of an information processing apparatus according to the present disclosure;

FIG. 2 is a flowchart illustrating a flow of an information processing method according to the present disclosure;

FIG. 3 is a block diagram illustrating a configuration of an information processing apparatus according to the present disclosure;

FIG. 4 is a flowchart illustrating a flow of an information processing method according to the present disclosure;

FIG. 5 is a block diagram illustrating a configuration of an information processing apparatus according to the present disclosure;

FIG. 6 is a diagram for describing processing in the information processing apparatus according to the present disclosure;

FIG. 7 is a diagram for describing a flow of processing in the information processing apparatus according to the present disclosure;

FIG. 8 is a diagram for describing processing in the information processing apparatus according to the present disclosure;

FIG. 9 is a diagram illustrating a network configuration example in the information processing apparatus according to the present disclosure;

FIG. 10 is a diagram for describing a flow of processing in the information processing apparatus according to the present disclosure;

FIG. 11 is a diagram for describing a flow of processing in the information processing apparatus according to the present disclosure;

FIG. 12 is a diagram for describing a flow of processing in the information processing apparatus according to the present disclosure;

FIG. 13 is a block diagram illustrating a configuration of an information processing apparatus according to the present disclosure; and

FIG. 14 is a block diagram illustrating a hardware configuration of the information processing apparatus according to the present disclosure.

### EXAMPLE EMBODIMENT

A (The) program can be stored and provided to a computer using any type of non-transitory computer readable media. Non-transitory computer readable media include any type of tangible storage media. Examples of non-transitory computer readable media include magnetic storage media (such as floppy disks, magnetic tapes, hard disk drives, etc.), optical magnetic storage media (e.g. magneto-optical disks), CD-ROM (compact disc read only memory), CD-R (compact disc recordable), CD-R/W (compact disc rewritable), and semiconductor memories (such as mask ROM, PROM (programmable ROM), EPROM (erasable PROM), flash ROM, RAM (random access memory), etc.). The program may be provided to a computer using any type of transitory computer readable media. Examples of transitory computer readable media include electric signals, optical signals, and electromagnetic waves. Transitory computer readable media can provide the program to a computer via a wired communication line (e.g. electric wires, and optical fibers) or a wireless communication line.

Hereinafter, example embodiments of the present disclosure will be exemplified. However, the present disclosure is not limited to the exemplary example embodiments which will be described below, and various modifications can be made within the scope described in the claims. For example, example embodiments obtained by appropriately combining technical means adopted in the following exemplary example embodiments can also be included in the scope of the present disclosure. In addition, example embodiments obtained by appropriately omitting some of the technical means adopted in the following exemplary example embodiments can also be included in the scope of the present disclosure. In addition, effects mentioned in the following exemplary example embodiments are examples of effects expected in the exemplary example embodiments, and do not define the extension of the present disclosure. That is, example embodiments that do not achieve the effects mentioned in the following exemplary example embodiments can also be included in the scope of the present disclosure.

### First Example Embodiment

A first exemplary example embodiment that is an example of an example embodiment of the present disclosure will be described in detail with reference to the drawings. The present exemplary example embodiment is a basic form of each exemplary example embodiment which will be described below. Note that the application range of each technical means adopted in the present exemplary example embodiment is not limited to the present exemplary example embodiment. That is, each technical means adopted in the present exemplary example embodiment can also be adopted in other exemplary example embodiments included in the present disclosure as long as no particular technical problem occurs. In addition, each technical means illustrated in the drawings referred to for describing the present exemplary example embodiment can also be adopted in other exemplary example embodiments included in the present disclosure as long as no particular technical problem occurs.

### Configuration of Information Processing Apparatus 1

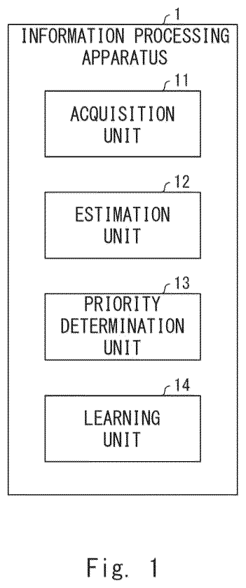

A configuration of an information processing apparatus 1 according to the present exemplary example embodiment will be described with reference to FIG. 1. FIG. 1 is a block diagram illustrating a configuration of the information processing apparatus 1. The information processing apparatus 1 may also be referred to as an image processing apparatus, a learning apparatus, or the like. As illustrated in FIG. 1, the information processing apparatus 1 includes an acquisition unit 11, an estimation unit 12, a priority determination unit 13, and a learning unit 14.

### Acquisition Unit 11

The acquisition unit 11 acquires input data including a plurality of images under a plurality of illumination conditions. Here, the input data is, for example, input data for a learning phase. Further, the plurality of images included in the input data may be, as an example,
a plurality of captured images (live-action images) captured by an imaging apparatus under a plurality of mutually different illumination conditions and obtained by imaging one or a plurality of objects, or
a plurality of images (CG and the like) generated by an image generation apparatus under a plurality of mutually different illumination conditions and including one or a plurality of objects.

For example, in an environment in which light sources 1 to 3 are disposed, the plurality of images may be
image 1 obtained by imaging an object under illumination condition 1 (in which light source 1 is turned on)
image 2 obtained by imaging an object under illumination condition 2 (in which light source 2 is turned on)
image 3 obtained by imaging an object under illumination condition 3 (in which light source 3 is turned on), and the like. Here, the “object” may be a living body or a non-living body, and does not limit the present exemplary example embodiment at all.

In addition, the plurality of images included in the input data are, for example, RGB data (RGB images) in which each pixel (data point) represents an RGB value, but are not limited thereto. Further, in addition to the plurality of images, the input data may include, as data regarding the object, at least one of
depth data (depth image) in which each pixel (data point) represents a depth value
three-dimensional point cloud data in which each data point represents three-dimensional coordinates. The three-dimensional point cloud data may be, as an example, point cloud data acquired by a line laser scanner, but the example is not intended to limit the present exemplary example embodiment.

### Estimation Unit 12

The estimation unit 12 executes normal estimation processing and depth estimation processing using an estimation model with reference to the input data. Here, the estimation model is a target of learning in learning processing executed by the information processing apparatus 1. In addition, a specific configuration of the estimation unit 12 is not limited to the present exemplary example embodiment, but as an example, the estimation unit 12 may be configured to execute, using the estimation model described above,
first extraction processing of extracting one or a plurality of first feature amounts from the plurality of images included in the input data,
second extraction processing of extracting one or a plurality of second feature amounts from depth information obtained from the input data, and
the normal estimation processing and the depth estimation processing with reference to the first feature amounts and the second feature amounts. Furthermore, in a case where the input data includes the depth image and the three-dimensional point cloud data described above, the estimation unit 12 may be configured to execute.
processing of extracting the one or the plurality of second feature amounts from the depth image or the three-dimensional point cloud data as the depth information
or in a case where the input data does not include the depth image or the three-dimensional point cloud data, the estimation unit 12 may be configured to further execute
depth information generation processing of generating the depth information from the plurality of images included in the input data.

In addition, the format of data indicating the result of each of the normal estimation processing and the depth estimation processing is not particularly limited, but as an example, may be a set of two-dimensional data points corresponding to the images included in the input data. As an example, the result of the normal estimation processing may be represented in the form of a normal estimation map, and the result of the depth estimation processing may be represented in the form of a depth estimation map.

### Priority Determination Unit 13

The priority determination unit 13 determines priorities of the normal estimation processing and the depth estimation processing. Details of priority determination processing performed by the priority determination unit 13 do not limit the present exemplary example embodiment, but as an example, the priority may be determined with reference to at least one of the plurality of images included in the input data, a result of the normal estimation processing, and a result of the depth estimation processing.

As an example, the priority determination unit 13 may determine, as the respective priorities,
a weighting coefficient W_{NR} by which a result NR of the normal estimation processing is multiplied
a weighting coefficient W_{DR} by which a result DR of the depth estimation processing is multiplied. Here, as an example, the priority determination unit 13 sets a larger weight to processing having a higher priority between the normal estimation processing and the depth estimation processing. As an example, the priority determination unit 13 may be configured to execute determination processing regarding which result of the normal estimation processing and the depth estimation processing is more reliable, and to give higher priority to processing determined to be more reliable. However, the examples are not intended to limit the present exemplary example embodiment.

Further, the priority determination unit 13 may be configured to calculate a local priority as the priority. As an example, the priority determination unit 13 may be configured to determine the priority for each partial region or each data point in the normal estimation map and the depth estimation map described above. In the case of this configuration, the weighting coefficients calculated by the priority determination unit 13 can also be represented as (W_{NR})_{i,j}, (W_{DR})_{i,j}, and the like using a two-dimensional index (i, j) designating each partial region or each data point in the normal estimation map or the depth estimation map.

### Learning Unit 14

The learning unit 14 trains the estimation model using a loss function according to the result of the normal estimation processing, the result of the depth estimation processing, and the priorities. As an example, the learning unit 14 calculates a loss function LF according to
a first loss value L_{NR} representing a difference between the result NR of the normal estimation processing and ground truth data regarding the normal,
a second loss value L_{DR} representing a difference between the result DR of the depth estimation processing and ground truth data regarding the depth, and
the priority, and updates a plurality of parameters defining the estimation model such that a value of the loss function LF decreases.

More specifically, as an example, the learning unit 14 may calculate the loss function LF according to LF =W_{NR}×L_{NR}+W_{DR}×L_{DR} using the weighting coefficients W_{NR} and W_{DR} serving as the priorities, and update a plurality of parameters defining the estimation model such that the value of the loss function LF decreases.

Furthermore, the learning unit 14 may be configured to calculate a local loss function as the loss function. As an example, the priority determination unit 13 may be configured to calculate the loss function for each partial region or each data point in the normal estimation map and the depth estimation map described above. In the case of this configuration, the weighting coefficients calculated by the learning unit 14 can also be represented as LF_{i,j}=(W_{NR})_{i,j}×(L_{NR})_{i,j}+(W_{DR})_{i,j}×(L_{DR})_{i,j} using a two-dimensional index (i, j) that designates each partial region or each data point in the normal estimation map or the depth estimation map, and the sum of the local loss function can also be represented as LF=ΣLF_{i,j}. Here, Σ represents a sum related to the two-dimensional index (i, j).

In a case where the plurality of images included in the input data are a plurality of images (CG and the like) generated by an image generation apparatus as described above, as the ground truth data,
a normal map and a depth map derived from the image data generated by the image generation apparatus may be used.

Further, in a case where the plurality of images included in the input data are a plurality of captured images (live-action images) captured by an imaging apparatus as described above, as the ground truth data,
a normal map obtained by referring to data obtained by actually measuring an imaged object, and a depth map may be used. However, these examples are not intended to limit the present exemplary example embodiment.

### Effects of Information Processing Apparatus 1

As described above, the information processing apparatus 1 adopts a configuration of
acquiring input data including a plurality of images under a plurality of illumination conditions,
executing normal estimation processing and depth estimation processing using an estimation model with reference to the input data,
determining priority of each of the normal estimation processing and the depth estimation processing, and
training the estimation model using a loss function according to a result of the normal estimation processing, a result of the depth estimation processing, and the priorities. According to the above configuration, the priority of each of the normal estimation processing and the depth estimation processing is determined, and the estimation model is trained using a loss function according to a result of the normal estimation processing, a result of the depth estimation processing, and the priorities. Therefore, according to the above configuration,
reconfiguration of local details of an object based on the normal estimation processing, and
reconfiguration of a global three-dimensional shape of the object based on the depth estimation processing is suitably realized. In other words, according to the above configuration, both the local details and the global three-dimensional shape of the object can be suitably reconstructed.

### Flow of Information Processing Method S1

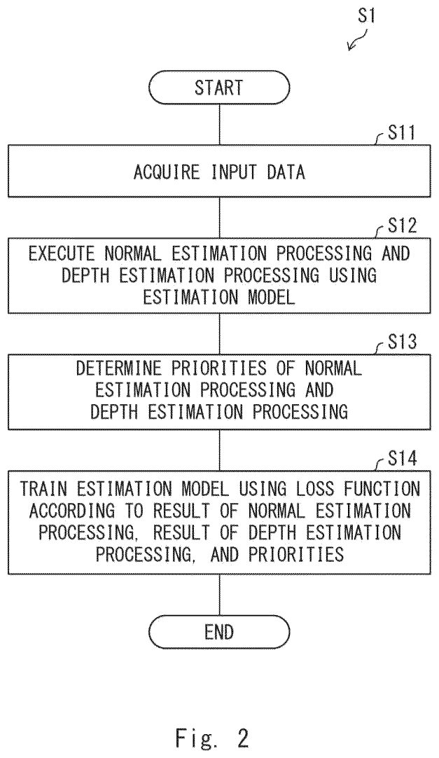

Next, a flow of an information processing method S1 according to the present exemplary example embodiment will be described with reference to FIG. 2. FIG. 2 is a flowchart illustrating the flow of the information processing method S1. As illustrated in FIG. 2, the information processing method S1 includes step (processing) S11 of acquiring input data, step (processing) S12 of executing normal estimation processing and depth estimation processing, step (processing) S13 of determining priority of each of the normal estimation processing and the depth estimation processing, and step (processing) S14 of training an estimation model using a loss function.

### Step S11

In step S11, the acquisition unit 11 acquires input data including a plurality of images under a plurality of illumination conditions. Since specific processing performed by the acquisition unit 11 has been described above, the description thereof will be omitted here.

### Step S12

Subsequently, in step S12, the estimation unit 12 executes normal estimation processing and depth estimation processing using the estimation model with reference to the input data. Since specific processing performed by the estimation unit 12 has been described above, the description thereof will be omitted here.

### Step S13

Subsequently, in step S14, the priority determination unit 13 determines priorities of the normal estimation processing and the depth estimation processing. Since specific processing performed by the priority determination unit 13 has been described above, the description thereof will be omitted here.

### Step S14

Subsequently, in step S13, the learning unit 14 trains the estimation model using a loss function according to a result of the normal estimation processing, a result of the depth estimation processing, and the priorities. Since specific processing performed by the learning unit 14 has been described above, the description thereof will be omitted here.

Note that the processing from step S12 to step S14 may be repeatedly executed a plurality of times until the value of the loss function satisfies a predetermined convergence condition. However, the examples are not intended to limit the present exemplary example embodiment.

### Effects of Information Processing Method S1

As described above, in the information processing method S1, a configuration of
acquiring input data including a plurality of images under a plurality of illumination conditions,
executing normal estimation processing and depth estimation processing using an estimation model with reference to the input data,
determining priorities of the normal estimation processing and the depth estimation processing, and
training the estimation model using a loss function according to a result of the normal estimation processing, a result of the depth estimation processing, and the priorities is adopted. According to the above configuration, effects similar to those of the information processing apparatus 1 are obtained.

### Configuration of Information Processing Apparatus 2

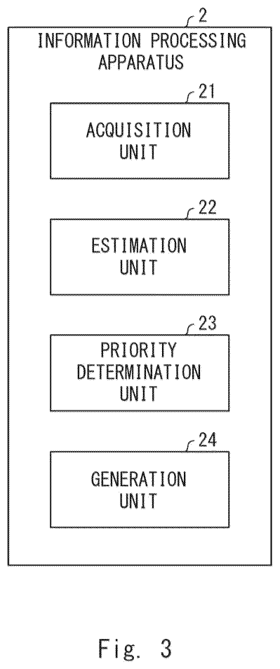

Next, a configuration of an information processing apparatus 2 according to the present exemplary example embodiment will be described with reference to FIG. 3. FIG. 3 is a block diagram illustrating the configuration of the information processing apparatus 2. The information processing apparatus 2 may also be referred to as an image generation apparatus, an inference apparatus, or the like. As illustrated in FIG. 3, the information processing apparatus 2 includes an acquisition unit 21, an estimation unit 22, a priority determination unit 23, and a generation unit 24.

### Acquisition Unit 21

The acquisition unit 21 acquires input data including a plurality of images under a plurality of illumination conditions. Here, the input data is, for example, input data for an inference phase. Further, the plurality of images included in the input data may be, as an example,
a plurality of captured images (live-action images) captured by an imaging apparatus under a plurality of mutually different illumination conditions and obtained by imaging one or a plurality of objects, or
a plurality of images (CG and the like) generated by an image generation apparatus under a plurality of mutually different illumination conditions and including one or a plurality of objects.

For example, in an environment in which light sources 1 to 3 are disposed, the plurality of images may be
image 1 obtained by imaging an object under illumination condition 1 (in which light source 1 is turned on)
image 2 obtained by imaging an object under illumination condition 2 (in which light source 2 is turned on)
image 3 obtained by imaging an object under illumination condition 3 (in which light source 3 is turned on), and the like. Here, the “object” may be a living body or a non-living body, and does not limit the present exemplary example embodiment at all.

In addition, the plurality of images included in the input data are, for example, RGB data (RGB images) in which each pixel (data point) represents an RGB value, but are not limited thereto. Further, in addition to the plurality of images, the input data may include, as data regarding the object, at least one of
depth data (depth image) in which each pixel (data point) represents a depth value
three-dimensional point cloud data in which each data point represents three-dimensional coordinates. The three-dimensional point cloud data may be, as an example, point cloud data acquired by a line laser scanner, but the example is not intended to limit the present exemplary example embodiment.

### Estimation Unit 22

The estimation unit 22 executes normal estimation processing and depth estimation processing with reference to the input data. Here, as an example, the normal estimation processing and the depth estimation processing may be configured to be executed by an estimation model trained (parameter updated) by the learning unit 14 included in the information processing apparatus 1. However, this is not intended to limit the present exemplary example embodiment. In addition, a specific configuration of the estimation unit 22 is not limited to the present exemplary example embodiment, but as an example, the estimation unit 22 may be configured to execute, using the estimation model described above,
first extraction processing of extracting one or a plurality of first feature amounts from the plurality of images included in the input data,
second extraction processing of extracting one or a plurality of second feature amounts from depth information obtained from the input data, and
the normal estimation processing and the depth estimation processing with reference to the first feature amounts and the second feature amounts. Furthermore, in a case where the input data includes the depth image and the three-dimensional point cloud data described above, the estimation unit 22 may be configured to execute
processing of extracting the one or the plurality of second feature amounts from the depth image or the three-dimensional point cloud data as the depth information,
or in a case where the input data does not include the depth image or the three-dimensional point cloud data, the estimation unit 22 may be configured to further execute
depth information generation processing of generating the depth information from the plurality of images included in the input data.

In addition, the format of data indicating the result of each of the normal estimation processing and the depth estimation processing is not particularly limited, but as an example, may be a set of two-dimensional data points corresponding to the images included in the input data. As an example, the result of the normal estimation processing may be represented in the form of a normal estimation map, and the result of the depth estimation processing may be represented in the form of a depth estimation map.

### Priority Determination Unit 23

The priority determination unit 23 determines priority of each of the normal estimation processing and the depth estimation processing. Details of priority determination processing performed by the priority determination unit 23 do not limit the present exemplary example embodiment, but as an example, the priority may be determined with reference to at least one of the plurality of images included in the input data, a result of the normal estimation processing, and a result of the depth estimation processing.

As an example, the priority determination unit 23 may determine, as the respective priorities,
a weighting coefficient W_{NR} by which a result NR of the normal estimation processing is multiplied
a weighting coefficient W_{DR} by which a result DR of the depth estimation processing is multiplied. Here, as an example, the priority determination unit 13 sets a larger weight to processing having a higher priority between the normal estimation processing and the depth estimation processing. As an example, the priority determination unit 23 may be configured to execute determination processing regarding which result of the normal estimation processing and the depth estimation processing is more reliable, and to give higher priority to processing determined to be more reliable. However, the examples are not intended to limit the present exemplary example embodiment.

Further, the priority determination unit 23 may be configured to calculate a local priority as the priority. As an example, the priority determination unit 23 may be configured to determine the priority for each partial region or each data point in the normal estimation map and the depth estimation map described above. In the case of this configuration, the weighting coefficients calculated by the priority determination unit 23 can also be represented as (W_{NR})_{i,j}, (W_{DR})_{i,j}, and the like using a two-dimensional index (i, j) designating each partial region or each data point in the normal estimation map or the depth estimation map.

### Generation Unit 24

The generation unit 24 generates output data with reference to a result of the normal estimation process, a result of the depth estimation process, and the priorities. The output data is, for example, three-dimensional data (also referred to as three-dimensional reconstructed data) related to the object included in the input data.

As an example, the generation unit 24 generates three-dimensional data as output data by integrating three-dimensional data obtained by referring to the result of the normal estimation processing and three-dimensional data obtained by referring to the result of the depth estimation processing according to each priority.

As an example, the generation unit 24 performs,
while executing processing of reconstructing three-dimensional data with reference to a result of the depth estimation processing,
in a region in which the priority of the normal estimation processing is equal to or higher than a predetermined threshold value (in other words, a region in which the priority determination unit 23 determines that the normal estimation processing should be prioritized), processing of replacing three-dimensional data in the region with an integral value of a result of the normal estimation processing.

In addition, the generation unit 24 may output a normal map and a depth map in addition to the three-dimensional data. In that case, the generation unit 24 may be configured to perform replacement processing using a differential value of a depth in a region where the priority related to the normal estimation processing is equal to or less than (or smaller than) the predetermined threshold value, and to perform replacement processing using an integral value of a normal in a region where the priority related to the depth estimation processing is equal to or greater than (or larger than) the predetermined threshold value with reference to the priorities determined by the priority determination unit 23.

### Effects of Information Processing Apparatus 2

As described above, the information processing apparatus 2 adopts a configuration of
acquiring input data including a plurality of images under a plurality of illumination conditions,
executing normal estimation processing and depth estimation processing with reference to the input data,
determining priority of each of the normal estimation processing and the depth estimation processing, and
generating output data with reference to a result of the normal estimation processing, a result of the depth estimation processing, and the priorities. According to the above configuration, priority of each of the normal estimation processing and the depth estimation processing is determined, and output data is generated with reference to a result of the normal estimation processing, a result of the depth estimation processing, and the priorities. Therefore, according to the above configuration,
reconfiguration of local details of an object based on the normal estimation processing, and
reconfiguration of a global three-dimensional shape of the object based on the depth estimation processing is suitably realized. In other words, according to the above configuration, both the local details and the global three-dimensional shape of the object can be suitably reconstructed.

### Flow of Information Processing Method S2

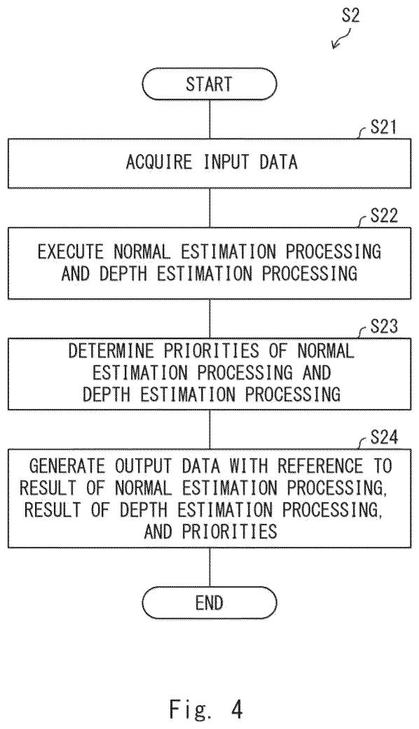

Next, a flow of an information processing method S2 according to the present exemplary example embodiment will be described with reference to FIG. 4. FIG. 4 is a flowchart illustrating the flow of the information processing method S2. As illustrated in FIG. 4, the information processing method S2 includes step (processing) S21 of acquiring input data, step (processing) S22 of executing normal estimation processing and depth estimation processing, step (processing) S23 of determining priority of each of the normal estimation processing and the depth estimation processing, and step (processing) S24 of generating output data.

### Step S21

In step S21, the acquisition unit 21 acquires input data including a plurality of images under a plurality of illumination conditions. Since specific processing performed by the acquisition unit 21 has been described above, the description thereof will be omitted here.

### Step S22

Subsequently, in step S22, the estimation unit 22 executes normal estimation processing and depth estimation processing with reference to the input data. Since specific processing performed by the estimation unit 22 has been described above, the description thereof will be omitted here.

### Step S23

Subsequently, in step S23, the priority determination unit 23 determines priority of each of the normal estimation processing and the depth estimation processing. Since specific processing performed by the priority determination unit 23 has been described above, the description thereof will be omitted here.

### Step S24

Subsequently, in step S24, the generation unit 24 generates output data with reference to a result of the normal estimation processing, a result of the depth estimation processing, and the priorities. Since specific processing performed by the generation unit 24 has been described above, the description thereof will be omitted here.

### Effects of Information Processing Method S2

As described above, in the information processing method S2, a configuration of
acquiring input data including a plurality of images under a plurality of illumination conditions,
executing normal estimation processing and depth estimation processing with reference to the input data,
determining priority of each of the normal estimation processing and the depth estimation processing, and
generating output data with reference to a result of the normal estimation processing, a result of the depth estimation processing, and the priorities is adopted. According to the above configuration, effects similar to those of the information processing apparatus 2 are obtained.

### Second Example Embodiment

A second exemplary example embodiment which is an example of an example embodiment of the present disclosure will be described in detail with reference to the drawings. Components having the same functions as the components described in the above-described exemplary example embodiment are denoted by the same reference numerals, and the description thereof will be appropriately omitted. Note that the application range of each technique adopted in the present exemplary example embodiment is not limited to the present exemplary example embodiment. That is, each technique adopted in the present exemplary example embodiment can also be adopted in other exemplary example embodiments included in the present disclosure as long as no particular technical problem occurs. Furthermore, each technique shown in each drawing referred to for describing the present exemplary example embodiment can also be employed in other exemplary example embodiments included in the present disclosure as long as no particular technical problem occurs.

### Configuration of Information Processing System 1A

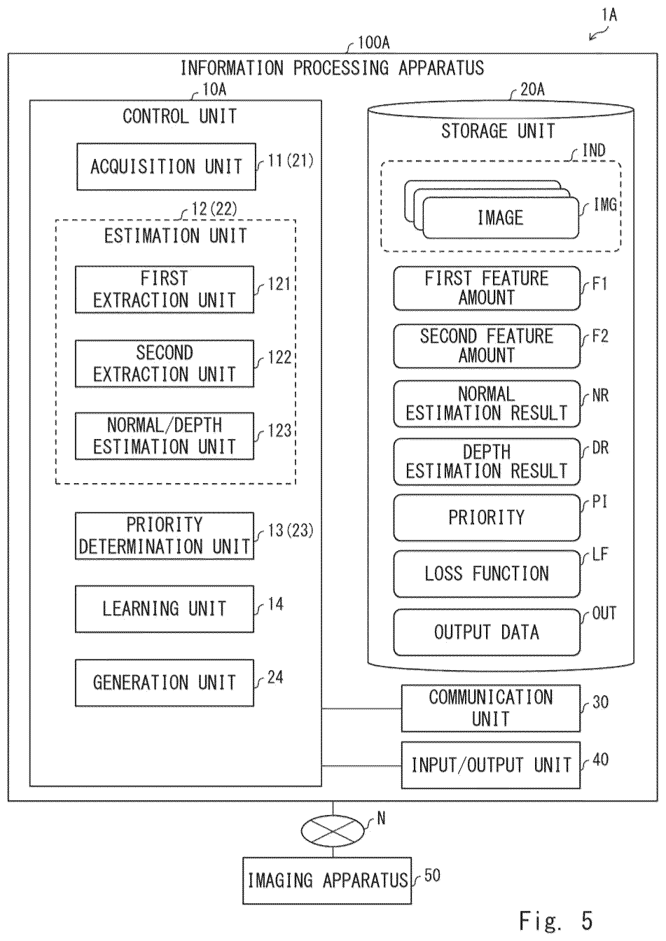

A configuration of an information processing system 1A according to the present exemplary example embodiment will be described with reference to FIG. 5. FIG. 5 is a block diagram illustrating a configuration of the information processing system 1A. As illustrated in FIG. 5, the information processing system 1A includes an information processing apparatus 100A and an imaging apparatus 50 connected to the information processing apparatus 100A via a network N. Here, the specific configuration of the network N is not limited to the present exemplary example embodiment, but as an example, a wireless local area network (LAN), a wired LAN, a wide area network (WAN), a public line network, a mobile data communication network, or a combination of these networks can be used.

### Imaging Apparatus 50

The imaging apparatus 50 acquires at least one of input data used in a learning phase which will be described later and input data used in an inference phase which will be described later. The imaging apparatus 50 may be an imaging apparatus that images one or a plurality of objects in the real world, or may have functions of an image generation apparatus that generates three-dimensional data in a virtual space.

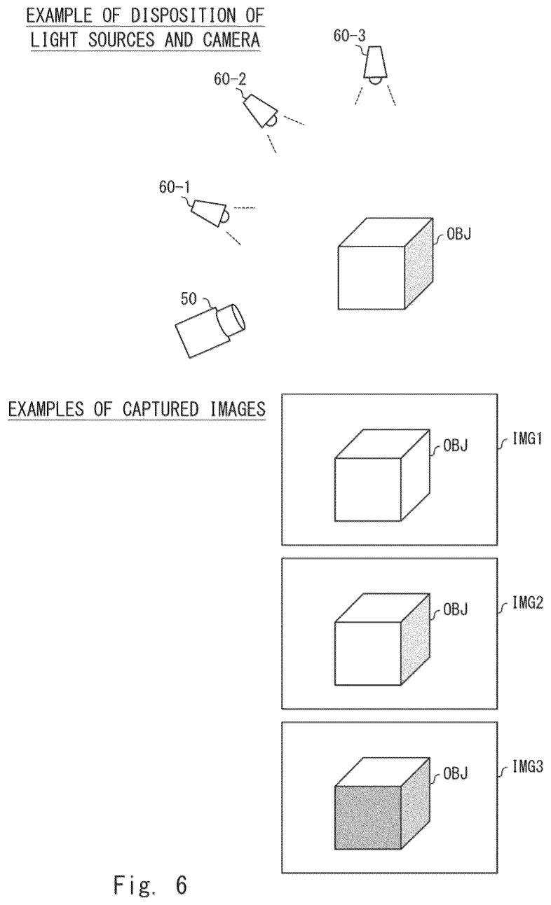

Images captured or generated by the imaging apparatus 50 include, as an example, a plurality of images under a plurality of illumination conditions. FIG. 6 is a diagram for describing images captured or generated by the imaging apparatus 50. As illustrated in the upper part of FIG. 6, an object OBJ is disposed, for example, in an environment in which a plurality of light sources (60-1 to 60-3) are disposed. Then, in the example illustrated in FIG. 6, the imaging apparatus 50 images the object OBJ under a plurality of illumination conditions.

As illustrated in the lower part of FIG. 6, a plurality of images captured in this manner can include
image 1 (IMG1 in FIG. 6) obtained by imaging the object OBJ under illumination condition 1 (in which light source 60-1 is turned on)
image 2 (IMG2 in FIG. 6) obtained by imaging the object OBJ under illumination condition 2 (in which light source 60-2 is turned on)
image 3 (IMG 3 in FIG. 6) obtained by imaging the object OBJ under illumination condition 3 (in which light source 60-3 is turned on), and the like.

The images captured or generated by the imaging apparatus 50 are acquired by the acquisition unit 11 (21) which will be described later.

### Configuration of Information Processing Apparatus 100A

Next, a configuration of the information processing apparatus 100A according to the present exemplary example embodiment will be described with reference to FIG. 5. FIG. 5 is a block diagram illustrating a configuration of the information processing apparatus 100A. As illustrated in FIG. 5, the information processing apparatus 100A includes a control unit 10A, a storage unit 20A, a communication unit 30, and an input/output unit 40.

### Communication Unit 30

The communication unit 30 communicates with an external apparatus of the information processing apparatus 100A via a network. As an example, the communication unit 30 transmits data supplied from the control unit 10A to the external apparatus, and supplies data received from the external apparatus to the control unit 10A. Note that the specific configuration of the network is not limited to the present exemplary example embodiment, but as an example, a wireless local area network (LAN), a wired LAN, a wide area network (WAN), a public network, a mobile data communication network, or a combination of these networks can be used.

### Input/Output Unit 40

The input/output unit 40 includes at least one of input/output devices such as a keyboard, a mouse, a display, a printer, and a touch panel. Alternatively, input/output devices such as a keyboard, a mouse, a display, a printer, and a touch panel may be connected to the input/output unit 40. In the case of this configuration, the input/output unit 40 receives inputs of various types of information to the information processing apparatus 100A from a connected input device. In addition, the input/output unit 40 outputs various types of information to a connected output device under the control of the control unit 10A. Examples of the input/output unit 40 include an interface such as a universal serial bus (USB).

### Storage Unit 20A

The storage unit 20A stores various types of data referred to by the control unit 10A and various types of data generated by the control unit 10A. As an example, in the storage unit 20A stores
input data IND including image group IMG
first feature amount F1
second feature amount F2
normal estimation result NR
depth estimation result DR
priority PI
loss function LF
output data OUT. Specific examples of such data will be described later.

### Control Unit 10A

As illustrated in FIG. 5, the control unit 10A includes the acquisition unit 11, the estimation unit 12, the priority determination unit 13, the learning unit 14, and the generation unit 24 described in exemplary example embodiment 1. Here, since the acquisition unit 11 can also be represented as having a configuration similar to that of the acquisition unit 21 described in exemplary example embodiment 1, the acquisition unit 11 may also be referred to as an acquisition unit 11 (21). Furthermore, since the estimation unit 12 can also be represented as having a configuration similar to that of the estimation unit 22 described in exemplary example embodiment 1, the estimation unit 12 may also be referred to as an estimation unit 12 (22). Further, since the priority determination unit 13 can be represented as having a configuration similar to that of the priority determination unit 23 described in exemplary example embodiment 1, the priority determination unit 13 may also be referred to as a priority determination unit 13 (23).

### Acquisition Unit 11 (21)

The acquisition unit 11 (21) acquires input data IND including a plurality of images IMG under a plurality of illumination conditions. Here, the acquisition unit 11 (21) acquires input data IND for learning in the learning phase and acquires input data IND for inference in the inference phase. In addition, as in exemplary example embodiment 1, the plurality of images IMG included in the input data IND may be, as an example,
a plurality of captured images (live-action images) captured by the imaging apparatus under a plurality of mutually different illumination conditions and obtained by imaging one or a plurality of objects, or
a plurality of images (CG and the like) generated by the image generation apparatus under a plurality of mutually different illumination conditions and including one or a plurality of objects.

For example, as illustrated in the lower part of FIG. 6, the plurality of images IMG may be
image 1 (IMG1 in FIG. 6) obtained by imaging the object OBJ under illumination condition 1 (in which light source 60-1 is turned on)
image 2 (IMG2 in FIG. 6) obtained by imaging the object OBJ under illumination condition 2 (in which light source 60-2 is turned on)
image 3 (IMG 3 in FIG. 6) obtained by imaging the object OBJ under illumination condition 3 (in which light source 60-3 is turned on), and the like. Here, the “object” may be a living body or a non-living body, and does not limit the present exemplary example embodiment at all.

In addition, the plurality of images IMG included in the input data is, for example, RGB data (RGB image) in which each pixel (data point) represents an RGB value, but are not limited thereto. Further, in addition to the plurality of images IMG, the input data may include, as data regarding the object, at least one of
depth data (depth image) in which each pixel (data point) represents a depth value, and
three-dimensional point cloud data in which each data point represents three-dimensional coordinates. The three-dimensional point cloud data may be, as an example, point cloud data acquired by a line laser scanner, but the example is not intended to limit the present exemplary example embodiment. Note that processing performed by the acquisition unit 11 (21) is similar to those performed by the acquisition unit 11 and the acquisition unit 21 according to exemplary example embodiment 1, for example, and thus redundant description may be omitted.

### Estimation Unit 12 (22)

The estimation unit 12 (22) executes normal estimation processing and depth estimation processing using an estimation model MD with reference to the input data IND. Here, the estimation unit 12 (22) executes the estimation processing using the inference model MD for learning in the learning phase, and executes the estimation processing using the trained inference model MD in the inference phase.

As illustrated in FIG. 5, the estimation unit 12 (22) includes, as an example, a first extraction unit 121, a second extraction unit 122, and a normal/depth estimation unit 123. Processing performed by each of these units corresponds to more specific processing related to the normal estimation processing and the depth estimation processing, and is executed by the estimation model MD as an example.

### First Extraction Unit 121

The first extraction unit 121 extracts one or a plurality of first feature amounts from the plurality of images included in the input data IND. Specific processing of the first extraction unit 121 will be described later.

### Second Extraction Unit 122

The second extraction unit 122 extracts one or a plurality of second feature amounts from depth information obtained from the input data IND. Specific processing of the second extraction unit 122 will be described later.

### Normal/Depth Estimation Unit 123

The normal/depth estimation unit 123 executes the normal estimation processing and the depth estimation processing with reference to the first feature amounts and the second feature amounts. Specific processing of the normal/depth estimation unit 123 will be described later.

### Priority Determination Unit 13 (23)

The priority determination unit 13 (23) determines priority of each of the normal estimation processing and the depth estimation processing. Details of priority determination processing performed by the priority determination unit 13 (23) do not limit the present exemplary example embodiment, but as an example, the priority may be determined with reference to at least one of the plurality of images included in the input data, a result of the normal estimation processing, and a result of the depth estimation processing. Specific processing of the priority determination unit 12 (23) will be described later.

### Learning Unit 14

The learning unit 14 trains the estimation model MD using a loss function according to a result of the normal estimation processing, a result of the depth estimation processing, and the priorities. As an example, the learning unit 14 calculates a loss function LF according to
a first loss value L_{NR} representing a difference between the result NR of the normal estimation processing and ground truth data regarding a normal,
a second loss value L_{DR} representing a difference between the result DR of the depth estimation processing and ground truth data regarding a depth, and
the priority, and
updates a plurality of parameters defining the estimation model MD such that a value of the loss function LF decreases. Specific processing of the learning unit 14 will be described later.

### Generation Unit 24

The generation unit 24 generates output data with reference to a result of the normal estimation process, a result of the depth estimation process, and the priorities. The output data is, for example, three-dimensional data (also referred to as three-dimensional reconstructed data) related to the object included in the input data.

As an example, the generation unit 24 generates three-dimensional data as output data by integrating three-dimensional data obtained by referring to the result of the normal estimation processing and three-dimensional data obtained by referring to the result of the depth estimation processing according to each priority.

As an example, the generation unit 24 performs,
while executing processing of reconstructing three-dimensional data with reference to a result of the depth estimation processing,
in a region in which the priority of the normal estimation processing is equal to or higher than a predetermined threshold value (in other words, a region in which the priority determination unit 23 determines that the normal estimation processing should be prioritized), processing of replacing three-dimensional data in the region with an integral value of a result of the normal estimation processing.

In addition, the generation unit 24 may output a normal map and a depth map in addition to the three-dimensional data. In that case, the generation unit 24 may be configured to perform replacement processing using a differential value of a depth in a region where the priority related to the normal estimation processing is equal to or less than (or smaller than) the predetermined threshold value, and to perform replacement processing using an integral value of a normal in a region where the priority related to the depth estimation processing is equal to or greater than (or larger than) the predetermined threshold value with reference to the priorities determined by the priority determination unit 13 (23).

### Example 1 of Processing Flow in Learning Phase

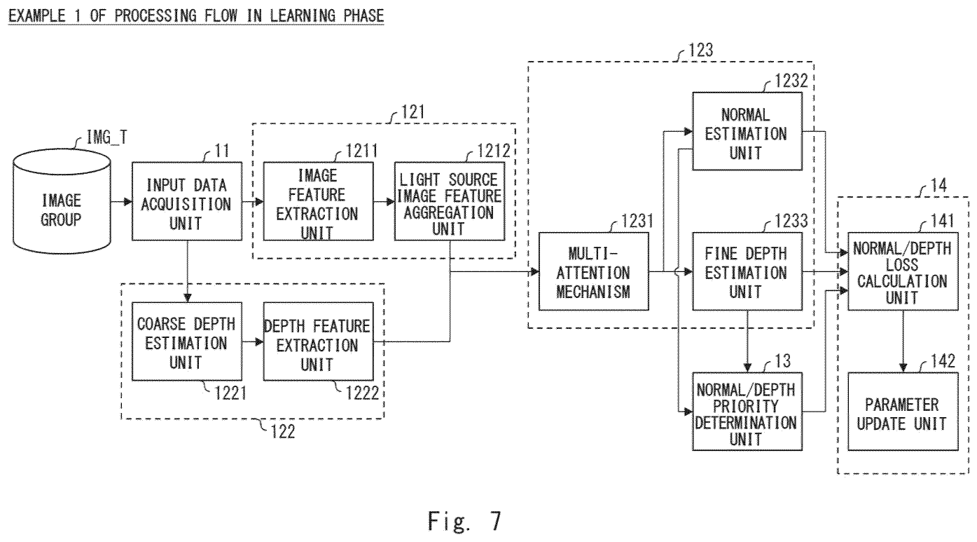

Next, an example of a flow of processing performed by the information processing apparatus 100A will be described while referring to a specific configuration example of the information processing apparatus 100A according to the present exemplary example embodiment with reference to FIG. 7. FIG. 7 is a diagram illustrating example 1 of a flow of processing performed by the information processing apparatus 100A in the learning phase.

First, input data IND including an image group IMG_T is acquired by the acquisition unit 11 (input data acquisition unit 11 in FIG. 7). Here, the notation of IMG_T is a notation for indicating that it is the plurality of images IMG described above and is an image in the learning phase, but this does not limit the present exemplary example embodiment. The input data IND is input to the first extraction unit 121 and the second extraction unit 122.

### First Extraction Unit 121

As described above, the first extraction unit 121 extracts one or a plurality of first feature amounts from the plurality of images IMG_T included in the input data IND. As illustrated in FIG. 7, the first extraction unit 121 includes an image feature extraction unit 1211 and a light source image feature aggregation unit 1212.

The image feature extraction unit 1211 is realized as an encoder as an example, and executes encoding processing of extracting one or a plurality of first feature amounts from each of the plurality of images IMG_T included in the input data IND. Here, in the encoding processing, processing of extracting the one or more first feature amounts may be performed for each of a plurality of regions or a plurality of data points included in each of the plurality of images IMG_T. Note that the encoding processing is an example of processing executed by the estimation model MD described above.

The light source image feature aggregation unit 1212 aggregates the first feature amounts extracted by the image feature extraction unit 1211 from each of the plurality of images IMG_T to generate an aggregated first feature amount. Here, the aggregation processing may be executed for each of the plurality of regions or the plurality of data points included in each of the plurality of images IMG_T. As an example, the light source image feature aggregation unit 1212 may be configured to generate a first feature amount FRI in a region R1 by aggregating
a first feature amount FR11 extracted in the region R1 in an image IMG_T1 obtained by imaging the object OBJ under illumination condition 1,
a first feature amount FR21 extracted in the region R1 in an image IMG_T2 obtained by imaging the object OBJ under illumination condition 2, and
a first feature amount FR31 extracted in the region R1 in an image IMG_T3 obtained by imaging the object OBJ under illumination condition 3.

Note that the aggregation processing performed by the light source image feature aggregation unit may include at least one of
processing 1: processing of summing components of each dimension in each of a plurality of first feature amounts; and
processing 2: processing of taking a maximum value of the components of each dimension in each of the plurality of first feature amounts. For example, as processing 1, processing of summing components of each dimension of
first feature amount FR11 extracted from the image IMG_T1=(0.1,0.2, . . . )
first feature amount FR21 extracted from the image IMG_T2=(0.2,0.4, . . . )
first feature amount FR31 extracted from the image IMG_T3=(0.3,0.1, . . . )
to generate
first feature amount FR1=(0.6, 0.7, . . . ) may be provided. The one or more first feature amounts aggregated by the light source image feature aggregation unit 1212 are supplied to a multi-attention mechanism 1231 which will be described later.

### Second Extraction Unit 122

As described above, the second extraction unit 122 extracts one or a plurality of second feature amounts from depth information obtained from the input data IND. As illustrated in FIG. 7, the second extraction unit 122 includes a coarse depth estimation unit 1221 and a depth feature extraction unit 1222.

The coarse depth estimation unit 1221 generates the depth information from the plurality of images included in the input data. As an example, the coarse depth estimation unit 1221 executes monocular depth estimation processing with reference to the plurality of images IMG_T included in the input data IND. As an example, the coarse depth estimation unit 1221 applies the monocular depth estimation processing to an image obtained by taking an average value or a median value of pixels of the plurality of images IMG_T. Alternatively, the coarse depth estimation unit 1221 may be configured to apply the monocular depth estimation processing to each of the images included in the plurality of images IMG_T. Here, as an example, the monocular depth estimation processing is executed for each of a plurality of regions or a plurality of data points included in each of the plurality of images IMG_T. More specifically, as an example, the coarse depth estimation unit 1221 averages
each pixel value of the image IMG_T1
each pixel value of the image IMG_T2
each pixel value of the image IMG_T3
for each pixel to generate an averaged image IMG_T, estimates a depth for each of a plurality of regions or a plurality of data points in the averaged image IMG_T, and supplies an image (also referred to as a depth image or depth information) indicating the estimation result to the depth feature extraction unit 1222. Note that the depth estimation processing is an example of processing executed by the estimation model MD described above.

The depth feature extraction unit 1222 extracts one or a plurality of second feature amounts from the depth image estimated by the coarse depth estimation unit 1221. The depth feature extraction unit 1222 is realized as an encoder as an example, and executes encoding processing of extracting one or a plurality of second feature amounts from the depth image. The depth feature extraction unit 1222 supplies the extracted one or plurality of second feature amounts to the multi-attention mechanism 1231 which will be described later. Note that the encoding processing is an example of processing executed by the estimation model MD described above.

### Normal/Depth Estimation Unit 123

As described above, the normal/depth estimation unit 123 executes normal estimation processing and fine depth estimation processing with reference to the first feature amounts and the second feature amounts. As illustrated in FIG. 7, the normal/depth estimation unit 123 includes the multi-attention mechanism 1231, a normal estimation unit 1232, and a fine depth estimation unit 1233.

The multi-attention mechanism 1231 executes multi-attention processing (multi-head attention processing as an example) with reference to the aggregated one or more first feature amounts supplied from the light source image feature aggregation unit 1212 and the one or more second feature amounts supplied from the depth feature extraction unit 1222. The multi-attention processing executed by the multi-attention mechanism 1231 can also be represented as processing of causing the aggregated one or plurality of first feature amounts supplied from the light source image feature aggregation unit 1212 and the one or plurality of second feature amounts supplied from the depth feature extraction unit 1222 to interact with each other. As an example, the multi-attention mechanism 1231 executing, as the multi-attention processing, processing of
allocating the aggregated one or plurality of first feature amounts and the one or plurality of second feature amounts to any one or a plurality of elements of a query Q, a key K, and a value V,
executing linear transformation using weights W^{Q}ᵢ, W^{K}ᵢ, and W^{V}ᵢ for each of the query Q, the key K, and the value V,
applying scaled dot-product attention processing to QW^{Q}ᵢ, KW^{K}ᵢ, and VW^{V}ᵢ after linear transformation,
concatenating the results of the scaled dot-product attention, and
outputting a result obtained by applying a weight W^{O} to the concatenated result as a result of the multi-attention processing. Note that the multi-attention mechanism 1231 may execute, as the multi-attention processing, cross attention processing of causing the aggregated one or plurality of first feature amounts and the one or plurality of second feature amounts to interact with each other.

The normal estimation unit 1232 executes normal estimation processing with reference to the result of the multi-attention processing. As an example, the normal estimation unit 1232 is realized as a decoder, and performs normal estimation by decoding processing with reference to the result of the multi-attention processing. As an example, the normal estimation result obtained by the normal estimation unit 1232 is represented in the form of a normal estimation map. The normal estimation result obtained by the normal estimation unit 1232 is supplied to the normal/depth loss calculation unit 141 and the normal/depth priority determination unit 13.

The fine depth estimation unit 1233 executes fine depth estimation processing with reference to the result of the multi-attention processing. The fine depth estimation unit 1233 is realized as a decoder, as an example, and performs fine depth estimation by decoding processing with reference to the result of the multi-attention processing. Here, the depth estimation processing executed by the fine depth estimation unit 1233 is processing with higher accuracy than the depth estimation processing executed by the coarse depth estimation unit 1221 described above. As an example, the depth estimation result obtained by the fine depth estimation unit 1233 is represented in the form of a depth estimation map. The depth estimation result obtained by the fine depth estimation unit 1233 is supplied to the normal/depth loss calculation unit 141 and the normal/depth priority determination unit 13. Note that the multi-attention processing, the normal estimation processing, and the depth estimation processing are also included in the processing executed by the estimation model MD described above.

### Normal/Depth Priority Determination Unit 13

The normal/depth priority determination unit 13 (corresponding to the priority determination unit 13) determines priority of each of the normal estimation processing performed by the normal estimation unit 1232 and the depth estimation processing performed by the fine depth estimation unit 1233. As an example, the normal/depth priority determination unit 13 determines which of the normal and the depth is prioritized for each of a plurality of regions or a plurality of data points included in the normal estimation map and the depth estimation map.

As described in exemplary example embodiment 1, as an example, the normal/depth priority determination unit 13 may determine, as the aforementioned priorities,
a weighting coefficient W_{NR} by which a result NR of the normal estimation processing is multiplied
a weighting coefficient W_{DR} by which a result DR of the depth estimation processing is multiplied. Here, as an example, the normal/depth priority determination unit 13 sets a larger weight to processing having a higher priority between the normal estimation processing and the depth estimation processing.

Furthermore, the normal/depth priority determination unit 13 may be configured to determine the priority for each region or each data point in the normal estimation map and the depth estimation map described above. In the case of this configuration, the weighting coefficients calculated by the normal/depth priority determination unit 13 can also be represented as (W_{NR})_{i,j}, (W_{DR})_{i,j}, and the like using a two-dimensional index (i, j) designating each region or each data point in the normal estimation map or the depth estimation map.

As an example, the normal/depth priority determination unit 13 executes any of examples which will be described below or a combination thereof.

### Example 1

For example, the normal/depth priority determination unit 13 may refer to the plurality of images IMG_T included in the input data IND, give priority to the weight of normal estimation in a region where light is sufficiently incident, and give priority to the weight of depth estimation in a region where light is not sufficiently incident, in the images.

More specifically, as an example, the normal/depth priority determination unit 13 may execute processing of
determining a degree of light reception under each of a plurality of illumination conditions in each of a plurality of regions or a plurality of data points included in the plurality of images IMG_T with reference to the plurality of images IMG_T included in the input data IND,
setting a high priority to the normal estimation processing in a region or a data point where it is determined that there is light reception of a predetermined degree or more in a larger number of images among the plurality of images, and
setting a low priority to the normal estimation processing in a region or a data point where it is determined that there is light reception of a predetermined degree or more in a smaller number of images among the plurality of images.

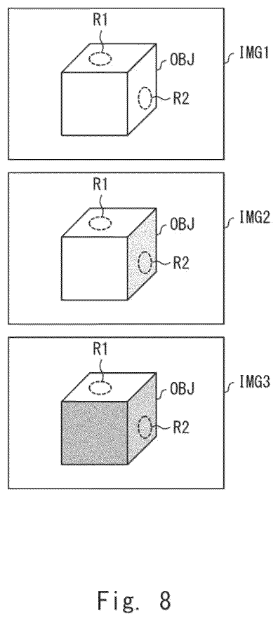

The above processing will be described below with reference to FIG. 8. In the example illustrated in FIG. 8, a region R1 and a region R2 are illustrated in the first image IMG1 to the third image IMG3 among the plurality of images IMG_T included in the input data IND.

As illustrated in FIG. 8, the region R1 has a satisfactory degree of light reception in all of the first image IMG1 to the third image IMG3. On the other hand, the region R2 has a satisfactory degree of light reception in the first image IMG1, but the degree of light reception decreases in the second image IMG2, and the degree of light reception further decreases in the third image IMG3.

In such a case, as an example, the normal/depth priority determination unit 13 performs processing of
determining that the degree of light reception of the region R1 is equal to or greater than a predetermined degree in all of the first image IMG1 to the third image IMG3,
determining that the degree of light reception of the region R2 is equal to or greater than the predetermined degree in the first image IMG1, but is less than the predetermined degree in the second image IMG2 and the third image IMG3, and
setting a higher priority to the normal estimation processing in the region R1, and setting a higher priority to the depth estimation processing in the region R2 (in other words, setting a lower priority to the normal estimation processing in the region R2) on the basis of the determination result.

### Example 2

In addition, the normal/depth priority determination unit 13 may perform processing of determining the priority for each region of the plurality of images IMG_T included in the input data IND such that the value of the loss function according to the result of the normal estimation processing, the result of the depth estimation processing, and the priorities decreases. The processing may be represented as processing of dynamically changing weights to minimize the loss indicated by the loss function in loss calculation. By performing such processing by the normal/depth priority determination unit 13, loss (normal loss) caused by normal estimation is prioritized in a region or data point where normal estimation is suitably executed, and loss (depth loss) caused by depth estimation is prioritized in a region or data point where depth estimation is suitably executed.

### Example 3

Furthermore, the fine depth estimation unit 1233 described above may also be configured to calculate reliability at the time of depth estimation in the depth estimation processing, and the normal/depth priority determination unit 13 may determine priority with reference to the reliability in the fine depth estimation unit 1233. As an example, the normal/depth priority determination unit 13 may perform processing of
determining a higher priority for the depth estimation processing in a region or a data point where the reliability is higher, and
determining a lower priority for the depth estimation processing in a region or a data point where the reliability is lower (in other words, determining a higher priority for the normal estimation processing).

### Example 4

Note that the normal/depth priority determination unit 13 may be configured to present the priority for each region determined by the above-describing processing to the user via the input/output unit 40. As an example, the normal/depth priority determination unit 13 may be configured to
generate a priority map indicating priority for each area,
present the priority map to the user via the input/output unit 40 along with the normal estimation map and the depth estimation map described above. In addition, an instruction from the user to which the priority is presented may be received, and the priorities for each area may be changed according to the instruction.

### Learning Unit 14

The learning unit 14 trains the estimation model MD using a loss function according to a result of the normal estimation processing, a result of the depth estimation processing, and the priorities. As an example, as illustrated in FIG. 7, the learning unit 14 includes the normal/depth loss calculation unit 141 and a parameter update unit 142.

The normal/depth loss calculation unit 141 calculates a loss function LF according to
a first loss value L_{NR} representing a difference between the result NR of the normal estimation processing and ground truth data regarding a normal,
a second loss value L_{DR} representing a difference between the result DR of the depth estimation processing and ground truth data regarding a depth, and
the priority.

More specifically, as an example, the learning unit 14 may calculate the loss function LF according to LF=W_{NR}×L_{NR}+W_{DR}×L_{DR} using the weighting coefficients W_{NR} and W_{DR} serving as the priorities, and update a plurality of parameters defining the estimation model such that the value of the loss function LF decreases.

Furthermore, the learning unit 14 may be configured to calculate a local loss function (loss function depending on a region) as the loss function. In the case of this configuration, the weighting coefficients calculated by the learning unit 14 can be represented as LF_{i,j}=(W_{NR})_{i,j}×(L_{NR})_{i,j}+(W_{DR})_{i,j}×(LDR)i,j using a two-dimensional index (i, j) that designates each region or each data point in the normal estimation map or the depth estimation map, and the sum of the local loss function can be represented as LF=ΣLF_{i,j}. Here, Σ represents a sum related to the two-dimensional index (i, j).

In a case where the plurality of images included in the input data are a plurality of images (CG and the like) generated by an image generation apparatus as described above, as the ground truth data,
a normal map and a depth map derived from the image data generated by the image generation apparatus may be used.

Furthermore, in a case where the plurality of images included in the input data are a plurality of captured images (live-action images) captured by the imaging apparatus 50 as described above,
a normal map and a depth map obtained by referring to data obtained by actually measuring the imaged object may be used as the ground truth data. However, these examples are not intended to limit the present exemplary example embodiment.

The parameter update unit 142 updates the plurality of parameters defining the estimation model MD such that the value of the loss function LF calculated as described above decreases. In other words, the parameter update unit 142 updates at least one of one or a plurality of parameters included in the estimation model MD that executes at least one of
processing of extracting the plurality of first feature amounts described above
processing of extracting the plurality of second feature amounts described above
multi-attention processing described above
normal estimation processing described above
depth estimation processing described above
priority determination processing described above
such that the value of the loss function LF decreases.

The updated parameters of the estimation model MD are stored in the storage unit 20A. Note that each processing performed by the first extraction unit 121, the second extraction unit 122, the normal/depth estimation unit 123, the priority determination unit 13, and the learning unit 14 may be repeatedly executed a plurality of times until the value of the loss function LF satisfies a predetermined convergence condition.

As described above, the information processing apparatus 100A adopts a configuration of
acquiring input data including a plurality of images under a plurality of illumination conditions,
executing normal estimation processing and depth estimation processing using an estimation model with reference to the input data,
determining priority of each of the normal estimation processing and the depth estimation processing, and
training the estimation model using a loss function according to a result of the normal estimation processing, a result of the depth estimation processing, and the priorities in the learning phase. In this manner, the information processing apparatus 100A determines the priority of each of the normal estimation processing and the depth estimation processing, and trains the estimation model using the loss function according to the result of the normal estimation processing, the result of the depth estimation processing, and the priorities. Therefore, according to the above configuration,
reconfiguration of local details of an object based on the normal estimation processing, and
reconfiguration of a global three-dimensional shape of the object based on the depth estimation processing is suitably realized. In other words, according to the above configuration, both the local details and the global three-dimensional shape of the object can be suitably reconstructed.

Note that the processing in the present example is not limited to the above example. For example, camera parameters may be input to the coarse depth estimation unit 1221. Here, as an example, the camera parameters include a focal length and an optical center of a camera when the above-described image group IMG_T is captured. Here, the camera parameters can be parameters common to the plurality of images included in the image group IMG_T, but this does not limit the present exemplary example embodiment. In addition, the coarse depth estimation unit 1221 may be configured to generate the depth information by monocular depth estimation assuming orthographic projection when generating the depth information from the plurality of images included in the image group IMG_T. By performing processing with reference to the camera parameters in the coarse depth estimation unit 1221, it is possible to improve the accuracy at the time of performing learning by projective projection.

### Network Configuration Example in Information Processing Apparatus 100A

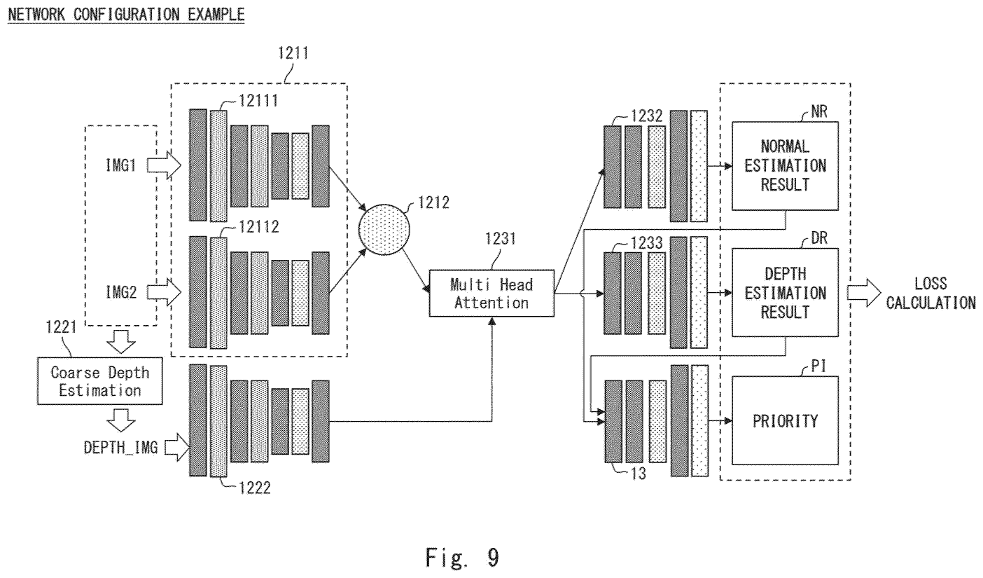

Next, a configuration example of a network (as an example, a neural network, the same applies in the following) in the information processing apparatus 100A will be described with reference to FIG. 9. As illustrated in FIG. 9, each of a plurality of images (IMG1 and IMG2 in FIG. 9) included in input data IND is input to each of a plurality of networks (reference numerals 12111 and 12112 in FIG. 9) constituting the image feature extraction unit 1211. Then, the first feature amounts, which are outputs of the plurality of networks 12111 and 12112, are aggregated by the light source image feature aggregation unit 1212.

On the other hand, each of the plurality of images (IMG1 and IMG2 in FIG. 9) included in the input data IND is referred to by the coarse depth estimation unit 1221 to generate a depth image (DEPTH_IMG in FIG. 9). Then, the depth image is input to a network constituting the depth feature extraction unit 1222, and one or a plurality of second feature amounts are extracted.

The aggregated first feature amount and the second feature amounts are input to the multi-attention mechanism 1231, and multi-attention processing is applied. Then, the result of the multi-attention processing is input to a network constituting the normal estimation unit 1232 and a network constituting the fine depth estimation unit 1233. Then, a normal estimation result NR obtained by the normal estimation unit 1232 and a depth estimation result DR obtained by the fine depth estimation unit 1233 are input to a network constituting the normal/depth priority determination unit 13. Then, the normal/depth priority determination unit 13 determines the priority of the normal estimation processing and the priority of the depth estimation processing with reference to these results. Then, the result of the normal estimation processing, the result of the depth estimation processing, and the priorities are used for loss calculation by the learning unit 14.

### Example 1 of Processing Flow in Inference Phase

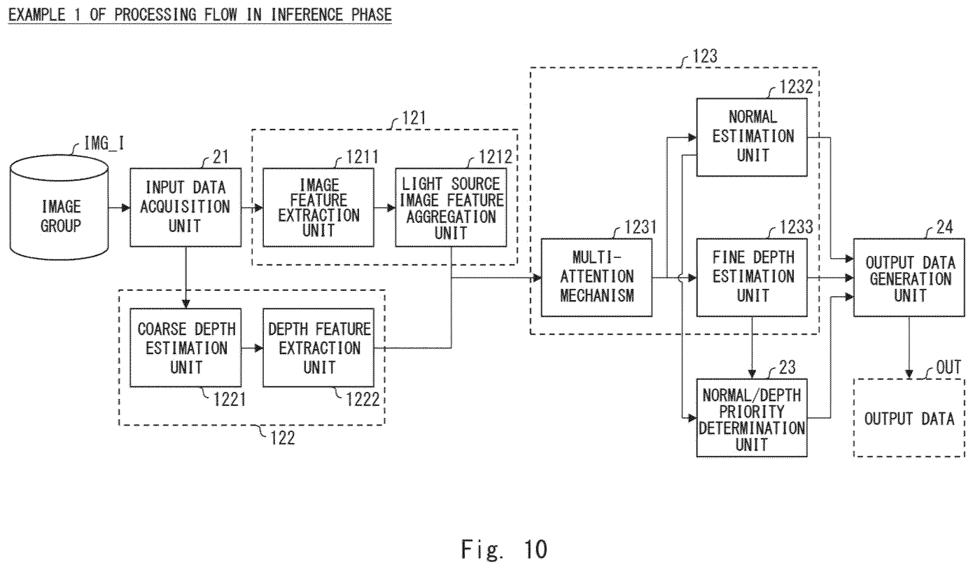

Next, another example of a flow of processing performed by the information processing apparatus 100A will be described with reference to FIG. 10 while referring to the specific configuration example of the information processing apparatus 100A according to the present exemplary example embodiment. FIG. 10 is a diagram illustrating example 1 of the flow of processing performed by the information processing apparatus 100A in the inference phase.

First, input data IND including an image group IMG_T is acquired by the acquisition unit 21 (input data acquisition unit 21 in FIG. 10). Here, the notation of IMG_I is a notation for indicating that it is the plurality of images IMG described above and is an image in the inference phase, but this does not limit the present exemplary example embodiment. The input data IND is input to the first extraction unit 121 and the second extraction unit 122.

### First Extraction Unit 121

As described above, the first extraction unit 121 extracts one or a plurality of first feature amounts from the plurality of images IMG_T included in the input data IND.

A configuration example and a processing example of the first extraction unit 121 are similar to the example described with reference to FIG. 7, and thus description thereof is omitted here. However, in the present example, each processing performed by the first extraction unit 121 is executed by an inference model MD trained in the above-described learning phase.

### Second Extraction Unit 122

As described above, the second extraction unit 122 extracts one or a plurality of second feature amounts from depth information obtained from the input data IND. A configuration example and a processing example of the second extraction unit 122 are similar to the example described with reference to FIG. 7, and thus description thereof is omitted here. However, in the present example, each processing performed by the second extraction unit 122 is executed by the inference model MD trained in the above-described learning phase.

### Normal/Depth Estimation Unit 123

As described above, the normal/depth estimation unit 123 executes normal estimation processing and fine depth estimation processing with reference to the first feature amounts and the second feature amounts. A configuration example and a processing example of the normal/depth estimation unit 123 are similar to the example described with reference to FIG. 7, and thus description thereof is omitted here. However, in the present example, each processing performed by the normal/depth estimation unit 123 is executed by the inference model MD trained in the learning phase described above.

### Normal/Depth Priority Determination Unit 23

The normal/depth priority determination unit 23 (corresponding to the priority determination unit 23) determines priority of each of the normal estimation processing performed by the normal estimation unit 1232 and the depth estimation processing performed by the fine depth estimation unit 1233. A configuration example and a processing example of the normal/depth priority determination unit 23 are similar to the configuration example and the processing example of the normal/depth priority determination unit 13 described with reference to FIG. 7, and thus the description thereof is omitted here. However, in the present example, each processing performed by the normal/depth priority determination unit 23 can be executed by the inference model MD trained in the learning phase described above.

### Output Data Generation Unit 24

The output data generation unit 24 (generation unit 24) generates output data with reference to the result of the normal estimation processing, the result of the depth estimation processing, and the priorities. The output data is, for example, three-dimensional data (also referred to as three-dimensional reconstructed data) related to the object included in the input data.

As an example, the output data generation unit 24 generates three-dimensional data as output data by integrating three-dimensional data obtained by referring to the result of the normal estimation processing and three-dimensional data obtained by referring to the result of the depth estimation processing according to each priority.

As an example, the output data generation unit 24 performs,
while executing processing of reconstructing three-dimensional data with reference to a result of the depth estimation processing,
in a region in which the priority of the normal estimation processing is equal to or higher than a predetermined threshold value (in other words, a region in which the priority determination unit 23 determines that the normal estimation processing should be prioritized), processing of replacing three-dimensional data in the region with an integral value of a result of the normal estimation processing.

In addition, the output data generation unit 24 may output a normal map and a depth map in addition to the three-dimensional data. In that case, the output data generation unit 24 may be configured to perform replacement processing using a differential value of a depth in a region where the priority related to the normal estimation processing is equal to or less than (or smaller than) the predetermined threshold value, and to perform replacement processing using an integral value of a normal in a region where the priority related to the depth estimation processing is equal to or greater than (or larger than) the predetermined threshold value with reference to the priorities determined by the priority determination unit 13 (23).

As described above, the information processing apparatus 100A adopts a configuration of
acquiring input data including a plurality of images under a plurality of illumination conditions,
executing normal estimation processing and depth estimation processing with reference to the input data,
determining priority of each of the normal estimation processing and the depth estimation processing, and
generating output data with reference to a result of the normal estimation processing, a result of the depth estimation processing, and the priorities in the inference phase. According to the above configuration, priority of each of the normal estimation processing and the depth estimation processing is determined, and output data is generated with reference to a result of the normal estimation processing, a result of the depth estimation processing, and the priorities. Therefore, according to the above configuration,
reconfiguration of local details of an object based on the normal estimation processing, and
reconfiguration of a global three-dimensional shape of the object based on the depth estimation processing is suitably realized. In other words, according to the above configuration, both the local details and the global three-dimensional shape of the object can be suitably reconstructed.

### Example 2 of Processing Flow in Learning Phase

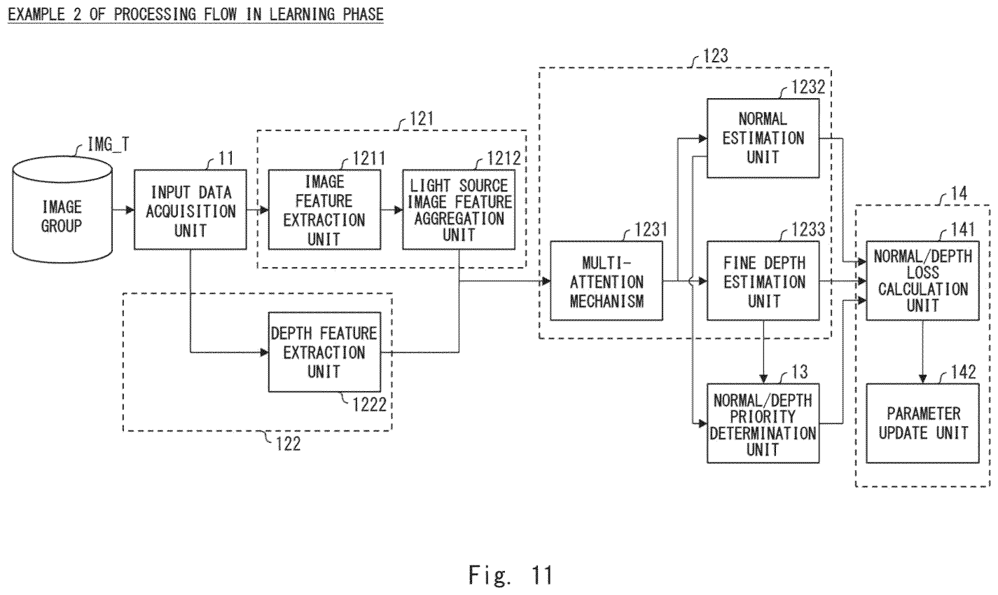

Next, another example of the flow of processing performed by the information processing apparatus 100A will be described with reference to FIG. 11 while referring to the specific configuration example of the information processing apparatus 100A according to the present exemplary example embodiment. FIG. 11 is a diagram illustrating example 2 of the flow of processing performed by the information processing apparatus 100A in the learning phase.

As illustrated in FIG. 11, in the present example, the second extraction unit 122 does not include the coarse depth estimation unit 1221. The present example adopts a configuration in which a depth image is included in the input data IND acquired by the input data acquisition unit 11, and the second extraction unit 122 extracts the one or plurality of second feature amounts from the depth image as depth information through the depth feature extraction unit 1222.

As an example, in the present exemplary example embodiment, the imaging apparatus 50 includes a depth camera, and may be configured to acquire, using the depth data,
data in which each pixel (data point) is depth data (depth image) representing a depth value and which represents an object OBJ, and
to include the data in the input data IND. Alternatively, the imaging apparatus 50 includes a line laser scanner, and may be configured to acquire, using the line laser scanner,
data which is three-dimensional point group data in which each data point represents three-dimensional coordinates and represents the object OBJ, and to include the data in the input data IND. Other configurations and processing according to the present example are similar to the configuration and processing described with reference to FIG. 7, and thus description thereof is omitted here. Such a configuration also achieves the above-described effects.

### Example 2 of Processing Flow in Inference Phase

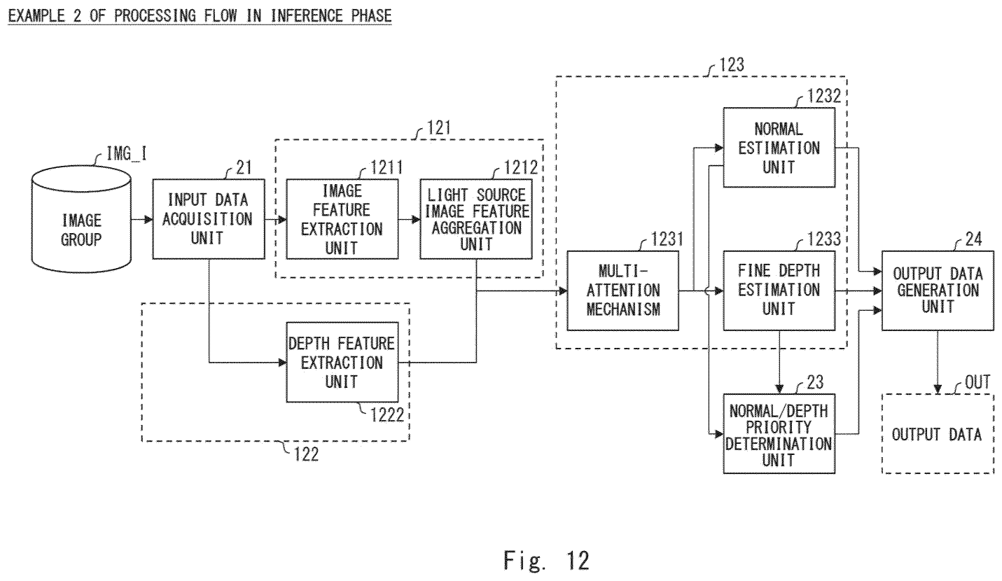

Next, another example of the flow of processing performed by the information processing apparatus 100A will be described with reference to FIG. 12 while referring to the specific configuration example of the information processing apparatus 100A according to the present exemplary example embodiment. FIG. 12 is a diagram illustrating example 2 of the flow of processing performed by the information processing apparatus 100A in the inference phase.

As illustrated in FIG. 12, in the present example, the second extraction unit 122 does not include the coarse depth estimation unit 1221. The present example adopts a configuration in which a depth image is included in the input data IND acquired by the input data acquisition unit 11, and the second extraction unit 122 extracts the one or plurality of second feature amounts from the depth image as depth information through the depth feature extraction unit 1222. Other configurations and processing according to the present example are similar to the configuration and processing described with reference to FIG. 10, and thus description thereof is omitted here. Such a configuration also achieves the above-described effects.

### Third Example Embodiment

A second exemplary example embodiment which is an example of an example embodiment of the present disclosure will be described in detail with reference to the drawings. Components having the same functions as the components described in the above-described exemplary example embodiment are denoted by the same reference numerals, and the description thereof will be appropriately omitted. Note that the application range of each technique adopted in the present exemplary example embodiment is not limited to the present exemplary example embodiment. That is, each technique adopted in the present exemplary example embodiment can also be adopted in other exemplary example embodiments included in the present disclosure as long as no particular technical problem occurs. Furthermore, each technique shown in each drawing referred to for describing the present exemplary example embodiment can also be employed in other exemplary example embodiments included in the present disclosure as long as no particular technical problem occurs.

### Configuration of Information Processing System 1B

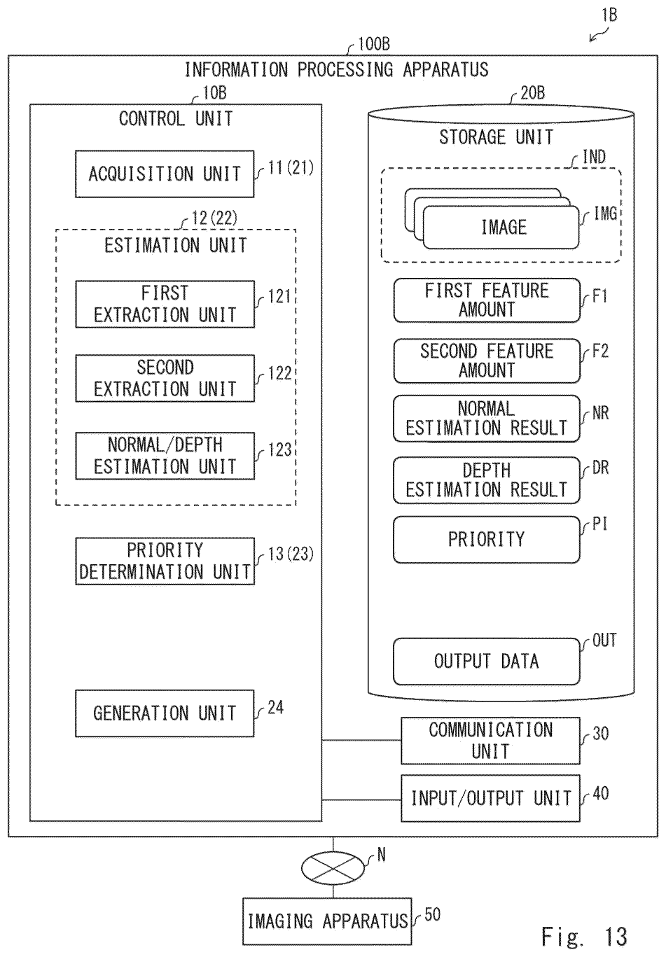

A configuration of an information processing system 1B according to the present exemplary example embodiment will be described with reference to FIG. 13. FIG. 13 is a block diagram illustrating a configuration of the information processing system 1B. As illustrated in FIG. 13, the information processing system 1B is different from the configuration described in exemplary example embodiment 2 in that an information processing apparatus 100B does not include the learning unit 14, and is similar to exemplary example embodiment 2 with respect to other points.

As an example, the estimation unit 12 (22) and the priority determination unit 13 (23) according to the present exemplary example embodiment execute each processing related to the inference phase using the inference model MD trained by the information processing apparatus 100A described above. Since the content of each processing related to the inference phase is similar to each processing in the inference phase executed by the information processing apparatus 100A described above, the description thereof will be omitted here.

### Implementation Example by Software

Some or all of the functions of the information processing apparatuses 1, 2, 100A, and 100B (hereinafter, also referred to as “each of the above-described apparatuses”) may be implemented by hardware such as an integrated circuit (IC chip) or may be implemented by software.

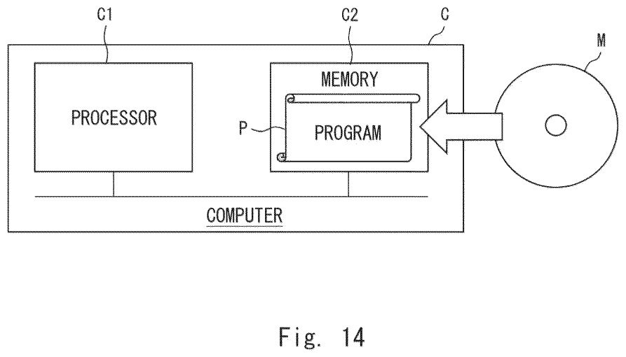

In the latter case, each of the above-described apparatuses is realized by, for example, a computer that executes commands of a program that is software for realizing each function. An example of such a computer (hereinafter, referred to as a computer C) is illustrated in FIG. 14. FIG. 14 is a block diagram illustrating a hardware configuration of the computer C functioning as each of the above-described apparatuses.

The computer C includes at least one processor C1 and at least one memory C2. A program P for operating the computer C as each of the above-described apparatuses is recorded in the memory C2. In the computer C, the processor C1 reads the program P from the memory C2 and executes the program P to realize each function of each of the above-described apparatuses.

As the processor C1, for example, a central processing unit (CPU), a graphic processing unit (GPU), a digital signal processor (DSP), a micro processing unit (MPU), a floating point number processing unit (FPU), a physics processing unit (PPU), a tensor processing unit (TPU), a quantum processor, a microcontroller, or a combination thereof can be used. As the memory C2, for example, a flash memory, a hard disk drive (HDD), a solid state drive (SSD), or a combination thereof can be used.

The computer C may further include a random access memory (RAM) for developing the program P at the time of execution and temporarily storing various types of data. Further, the computer C may further include a communication interface for transmitting and receiving data to and from other apparatuses. Further, the computer C may further include an input/output interface for connecting input/output devices such as a keyboard, a mouse, a display, and a printer.

In addition, the program P can be recorded on a non-transitory tangible recording medium M readable by the computer C. As such a recording medium M, for example, a tape, a disk, a card, a semiconductor memory, a programmable logic circuit, or the like can be used. The computer C can acquire the program P via such a recording medium M. In addition, the program P can be transmitted via a transmission medium. As such a transmission medium, for example, a communication network, broadcast waves, or the like can be used. The computer C can also acquire the program P via such a transmission medium.

### Supplementary Note A

The present disclosure includes the techniques described in the following supplementary notes. However, the present disclosure is not limited to the techniques described in the following supplementary notes, and various modifications can be made within the scope described in the claims.

### Supplementary Note A1

An information processing apparatus including:
an acquisition unit configured to acquire input data including a plurality of images under a plurality of illumination conditions;
an estimation unit configured to execute normal estimation processing and depth estimation processing with reference to the input data;
a priority determination unit configured to determine priorities of the normal estimation processing and the depth estimation processing; and
a generation unit configured to generate output data with reference to a result of the normal estimation processing, a result of the depth estimation processing, and the priorities.

### Supplementary Note A2

The information processing apparatus according to Supplementary Note A1, wherein the priority determination unit is configured to determine the priorities with reference to at least one of the plurality of images included in the input data, the result of the normal estimation processing, and the result of the depth estimation processing.

### Supplementary Note A3

The information processing apparatus according to Supplementary Note A2, wherein the estimation unit includes:
a first extraction unit configured to extract one or a plurality of first feature amounts from the plurality of images included in the input data;
a second extraction unit configured to extract one or a plurality of second feature amounts from depth information obtained from the input data; and
a normal/depth estimation unit configured to execute the normal estimation processing and the depth estimation processing with reference to the first feature amounts and the second feature amounts.

### Supplementary Note A4

The information processing apparatus according to Supplementary Note A3, wherein the second extraction unit includes a depth information generation unit configured to generate the depth information from the plurality of images included in the input data.

### Supplementary Note A5

The information processing apparatus according to Supplementary Note A3, wherein
the input data includes a depth image, and
the second extraction unit is configured to extract the one or the plurality of second feature amounts from the depth image as the depth information.

### Supplementary Note A6

The information processing apparatus according to any one of Supplementary Notes A3 to A5, wherein the normal/depth estimation unit includes:
a multi-attention processing unit configured to execute multi-attention processing with reference to the first feature amounts and the second feature amounts;
a normal estimation unit configured to execute the normal estimation processing with reference to a result of the multi-attention processing; and
a depth estimation unit configured to execute the depth estimation processing with reference to the result of the multi-attention processing.

### Supplementary Note A7

The information processing apparatus according to any one of Supplementary Notes A1 to A6, wherein the priority determination unit is configured to:
determine a degree of light reception under each of the plurality of illumination conditions in each of a plurality of regions included in the images with reference to the plurality of images included in the input data;
set a high priority to the normal estimation processing in a region in which it is determined that there is light reception of a predetermined degree or more in a larger number of images among the plurality of images; and
set a low priority to the normal estimation processing in a region in which it is determined that there is light reception of a predetermined degree or more in a smaller number of images among the plurality of images.

### Supplementary Note A8

The information processing apparatus according to any one of Supplementary Notes A1 to A7, wherein the priority determination unit is configured to determine the priorities such that a value of a loss function according to the result of the normal estimation processing, the result of the depth estimation processing, and the priorities decreases.

### Supplementary Note A9

The information processing apparatus according to any one of Supplementary Notes A1 to A8, wherein the estimation unit is configured to execute the normal estimation processing and the depth estimation processing using an estimation model,
the information processing apparatus further including a learning unit configured to train the estimation model using a loss function according to the result of the normal estimation processing, the result of the depth estimation processing, and the priorities.

### Supplementary Note A10

An information processing apparatus including:
an acquisition unit configured to acquire input data including a plurality of images under a plurality of illumination conditions;
an estimation unit configured to execute normal estimation processing and depth estimation processing using an estimation model with reference to the input data;
a priority determination unit configured to determine priorities of the normal estimation processing and the depth estimation processing; and
a learning unit configured to train the estimation model using a loss function according to a result of the normal estimation processing, a result of the depth estimation processing, and the priorities.

### Supplementary Note B

The present disclosure includes the techniques described in the following supplementary notes. However, the present disclosure is not limited to the techniques described in the following supplementary notes, and various modifications can be made within the scope described in the claims.

### Supplementary Note B1

An information processing method including:
acquisition processing of acquiring input data including a plurality of images under a plurality of illumination conditions by at least one processor;
estimation processing of executing normal estimation processing and depth estimation processing with reference to the input data by the at least one processor;
priority determination processing of determining priorities of the normal estimation processing and the depth estimation processing by the at least one processor; and
generation processing of generating output data with reference to a result of the normal estimation processing, a result of the depth estimation processing, and the priorities by the at least one processor.

### Supplementary Note B2

The information processing method according to Supplementary Note B1, wherein, in the priority determination processing, the at least one processor is configured to determine the priorities with reference to at least one of the plurality of images included in the input data, the result of the normal estimation processing, and the result of the depth estimation processing.

### Supplementary Note B3

The information processing method according to Supplementary Note B2, wherein the estimation processing includes:
first extraction processing of extracting one or a plurality of first feature amounts from the plurality of images included in the input data by the at least one processor;
second extraction processing of extracting one or a plurality of second feature amounts from depth information obtained from the input data by the at least one processor; and
normal/depth estimation processing of executing the normal estimation processing and the depth estimation processing with reference to the first feature amounts and the second feature amounts by the at least one processor.

### Supplementary Note B4

The information processing method according to Supplementary Note B3, wherein the second extraction processing includes depth information generation processing of generating the depth information from the plurality of images included in the input data by the at least one processor.

### Supplementary Note B5

The information processing method according to Supplementary Note B3, wherein
the input data includes a depth image, and
the second extraction processing extracts the one or the plurality of second feature amounts from the depth image as the depth information.

### Supplementary Note B6

The information processing method according to any one of Supplementary Notes B3 to B5, wherein the normal/depth estimation processing includes:
multi-attention processing of executing multi-attention processing with reference to the first feature amounts and the second feature amounts by the at least one processor;
normal estimation processing of executing the normal estimation processing with reference to a result of the multi-attention processing by the at least one processor; and
depth estimation processing of executing the depth estimation processing with reference to the result of the multi-attention processing by the at least one processor.

### Supplementary Note B7

The information processing method according to any one of Supplementary Notes B1 to B6, wherein, in the priority determination processing, the at least one processor is configured to:
determine a degree of light reception under each of the plurality of illumination conditions in each of a plurality of regions included in the images with reference to the plurality of images included in the input data;
set a high priority to the normal estimation processing in a region in which it is determined that there is light reception of a predetermined degree or more in a larger number of images among the plurality of images; and
set a low priority to the normal estimation processing in a region in which it is determined that there is light reception of a predetermined degree or more in a smaller number of images among the plurality of images.

### Supplementary Note B8

The information processing method according to any one of Supplementary Notes B1 to B7, wherein, in the priority determination processing, the at least one processor is configured to determine the priorities such that a value of a loss function according to the result of the normal estimation processing, the result of the depth estimation processing, and the priorities decreases.

### Supplementary Note B9

The information processing method according to any one of Supplementary Notes B1 to B8, wherein the estimation processing executes the normal estimation processing and the depth estimation processing using an estimation model,
the information processing method further including learning processing of training the estimation model by the at least one processor using a loss function according to the result of the normal estimation processing, the result of the depth estimation processing, and the priorities.

### Supplementary Note B10

An information processing method including:
acquisition processing of acquiring input data including a plurality of images under a plurality of illumination conditions by the at least one processor;
estimation processing of executing normal estimation processing and depth estimation processing using an estimation model with reference to the input data by the at least one processor;
priority determination processing of determining priorities of the normal estimation processing and the depth estimation processing by the at least one processor; and
learning processing of training the estimation model using a loss function according to the result of the normal estimation processing, the result of the depth estimation processing, and the priorities by the at least one processor.

### Supplementary Note C

The present disclosure includes the techniques described in the following supplementary notes. However, the present disclosure is not limited to the techniques described in the following supplementary notes, and various modifications can be made within the scope described in the claims.

### Supplementary Note C1

An information processing program for causing a computer to function as an information processing apparatus, the information processing program causing the computer to function as:
an acquisition unit configured to acquire input data including a plurality of images under a plurality of illumination conditions;
an estimation unit configured to execute normal estimation processing and depth estimation processing with reference to the input data;
a priority determination unit configured to determine priorities of the normal estimation processing and the depth estimation processing; and
a generation unit configured to generate output data with reference to a result of the normal estimation processing, a result of the depth estimation processing, and the priorities.

### Supplementary Note C2

The information processing program according to Supplementary Note C1, wherein the priority determination unit is configured to determine the priorities with reference to at least one of the plurality of images included in the input data, the result of the normal estimation processing, and the result of the depth estimation processing.

### Supplementary Note C3

The information processing program according to Supplementary Note C2, wherein the estimation unit is configured to cause the computer to function as:
a first extraction unit configured to extract one or a plurality of first feature amounts from the plurality of images included in the input data;
a second extraction unit configured to extract one or a plurality of second feature amounts from depth information obtained from the input data; and
a normal/depth estimation unit configured to execute the normal estimation processing and the depth estimation processing with reference to the first feature amounts and the second feature amounts.

### Supplementary Note C4

The information processing program according to Supplementary Note C3, wherein the second extraction unit is configured to cause the computer to function as depth information generation processing of generating the depth information from the plurality of images included in the input data.

### Supplementary Note C5

The information processing program according to Supplementary Note C3, wherein
the input data includes a depth image, and
the second extraction unit is configured to extract the one or the plurality of second feature amounts from the depth image as the depth information.

### Supplementary Note C6

The information processing program according to any one of Supplementary Notes C3 to C5, wherein the normal/depth estimation unit is configured to cause the computer to function as:
a multi-attention processing unit configured to execute multi-attention processing with reference to the first feature amounts and the second feature amounts;
a normal estimation unit configured to execute the normal estimation processing with reference to a result of the multi-attention processing; and
a depth estimation unit configured to execute the depth estimation processing with reference to the result of the multi-attention processing.

### Supplementary Note C7

The information processing program according to any one of Supplementary Notes C1 to C6, wherein the priority determination unit is configured to:
determine a degree of light reception under each of the plurality of illumination conditions in each of a plurality of regions included in the images with reference to the plurality of images included in the input data;
set a high priority to the normal estimation processing in a region in which it is determined that there is light reception of a predetermined degree or more in a larger number of images among the plurality of images; and
set a low priority to the normal estimation processing in a region in which it is determined that there is light reception of a predetermined degree or more in a smaller number of images among the plurality of images.

### Supplementary Note C8

The information processing program according to any one of Supplementary Notes C1 to C7, wherein the priority determination unit is configured to determine the priorities such that a value of a loss function according to the result of the normal estimation processing, the result of the depth estimation processing, and the priorities decreases.

### Supplementary Note C9

The information processing program according to any one of Supplementary Notes C1 to C8, wherein the estimation unit is configured to execute the normal estimation processing and the depth estimation processing using an estimation model,
the information processing apparatus being configured to cause the computer to further function as a learning unit configured to train the estimation model using a loss function according to the result of the normal estimation processing, the result of the depth estimation processing, and the priorities.

### Supplementary Note C10

An information processing program causing the computer to function as:
an acquisition unit configured to acquire input data including a plurality of images under a plurality of illumination conditions;
an estimation unit configured to execute normal estimation processing and depth estimation processing using an estimation model with reference to the input data;
a priority determination unit configured to determine priorities of the normal estimation processing and the depth estimation processing; and
a learning unit configured to train the estimation model using a loss function according to a result of the normal estimation processing, a result of the depth estimation processing, and the priorities.

### Supplementary Note D

The present disclosure includes the techniques described in the following supplementary notes. However, the present disclosure is not limited to the techniques described in the following supplementary notes, and various modifications can be made within the scope described in the claims.

### Supplementary Note D1

An information processing apparatus including at least one processor, the at least one processor is configured to execute:
acquisition processing of acquiring input data including a plurality of images under a plurality of illumination conditions;
estimation processing of executing normal estimation processing and depth estimation processing with reference to the input data;
priority determination processing of determining priorities of the normal estimation processing and the depth estimation processing; and
generation processing of generating output data with reference to a result of the normal estimation processing, a result of the depth estimation processing, and the priorities.

Note that the information processing apparatus may further include a memory. In addition, the memory may store a program for causing the at least one processor to execute each processing.

### Supplementary Note D2

The information processing apparatus according to Supplementary Note D1, wherein, in the priority determination processing, the at least one processor is configured to determine the priorities with reference to at least one of the plurality of images included in the input data, the result of the normal estimation processing, and the result of the depth estimation processing.

### Supplementary Note D3

The information processing apparatus according to Supplementary Note D2, wherein, in the estimation processing, the at least one processor is configured to execute:

first extraction processing of extracting one or a plurality of first feature amounts from the plurality of images included in the input data;

second extraction processing of extracting one or a plurality of second feature amounts from depth information obtained from the input data; and normal/depth estimation processing of executing the normal estimation processing and the depth estimation processing with reference to the first feature amounts and the second feature amounts.

### Supplementary Note D4

The information processing apparatus according to Supplementary Note D3, wherein the second extraction processing executes depth information generation processing of generating the depth information from the plurality of images included in the input data.

### Supplementary Note D5

The information processing apparatus according to Supplementary Note D3, wherein
the input data includes a depth image, and
the second extraction processing extracts the one or the plurality of second feature amounts from the depth image as the depth information.

### Supplementary Note D6

The information processing apparatus according to any one of Supplementary Notes D3 to D5, wherein, in the normal/depth estimation processing, the at least one processor is configured to execute:
multi-attention processing of executing multi-attention processing with reference to the first feature amounts and the second feature amounts;
normal estimation processing of executing the normal estimation processing with reference to a result of the multi-attention processing; and
depth estimation processing of executing the depth estimation processing with reference to the result of the multi-attention processing.

### Supplementary Note D7

The information processing apparatus according to any one of Supplementary Notes DI to D6, wherein, in the priority determination processing, the at least one processor is configured to:
determine a degree of light reception under each of the plurality of illumination conditions in each of a plurality of regions included in the images with reference to the plurality of images included in the input data;
set a high priority to the normal estimation processing in a region in which it is determined that there is light reception of a predetermined degree or more in a larger number of images among the plurality of images; and
set a low priority to the normal estimation processing in a region in which it is determined that there is light reception of a predetermined degree or more in a smaller number of images among the plurality of images.

### Supplementary Note D8

The information processing apparatus according to any one of Supplementary Notes D1 to D7, wherein, in the priority determination processing, the at least one processor is configured to determine the priorities such that a value of a loss function according to the result of the normal estimation processing, the result of the depth estimation processing, and the priorities decreases.

### Supplementary Note D9

The information processing apparatus according to any one of Supplementary Notes D1 to D8, wherein, in the estimation processing, the at least one processor is configured to execute the normal estimation processing and the depth estimation processing using an estimation model,
the information processing apparatus being configured to further execute learning processing of training the estimation model by the at least one processor using a loss function according to the result of the normal estimation processing, the result of the depth estimation processing, and the priorities.

### Supplementary Note D10

An information processing apparatus including the at least one processor configured to execute:
acquisition processing of acquiring input data including a plurality of images under a plurality of illumination conditions;
estimation processing of executing normal estimation processing and depth estimation processing using an estimation model with reference to the input data;
priority determination processing of determining priorities of the normal estimation processing and the depth estimation processing; and
learning processing of training the estimation model using a loss function according to a result of the normal estimation processing, a result of the depth estimation processing, and the priorities.

### Supplementary Note E

The present disclosure includes the techniques described in the following supplementary notes. However, the present disclosure is not limited to the techniques described in the following supplementary notes, and various modifications can be made within the scope described in the claims.

### Supplementary Note E1

A non-transitory recording medium storing an information processing program for causing a computer to function as an information processing apparatus, the program causing the computer to execute:
acquisition processing of acquiring input data including a plurality of images under a plurality of illumination conditions;
estimation processing of executing normal estimation processing and depth estimation processing with reference to the input data;
priority determination processing of determining priorities of the normal estimation processing and the depth estimation processing; and
generation processing of generating output data with reference to a result of the normal estimation processing, a result of the depth estimation process, and the priorities.

While the present disclosure has been particularly shown and described with reference to example embodiments thereof, the present disclosure is not limited to these example embodiments. It will be understood by those of ordinary skill in the art that various changes in form and details may be made therein without departing from the sprit and scope of the present disclosure as defined by the claims. And each embodiment can be appropriately combined with at least one of embodiments.

Each of the drawings or figures is merely an example to illustrate one or more example embodiments. Each figure may not be associated with only one particular example embodiment, but may be associated with one or more other example embodiments. As those of ordinary skill in the art will understand, various features or steps described with reference to any one of the figures can be combined with features or steps illustrated in one or more other figures, for example to produce example embodiments that are not explicitly illustrated or described. Not all of the features or steps illustrated in any one of the figures to describe an example embodiment are necessarily essential, and some features or steps may be omitted. The order of the steps described in any of the figures may be changed as appropriate.

What is claimed is:

1. An information processing apparatus comprising:
an acquisition unit configured to acquire input data including a plurality of images under a plurality of illumination conditions;
an estimation unit configured to execute normal estimation processing and depth estimation processing with reference to the input data;
a priority determination unit configured to determine priorities of the normal estimation processing and the depth estimation processing; and
a generation unit configured to generate output data with reference to a result of the normal estimation processing, a result of the depth estimation processing, and the priorities.

2. The information processing apparatus according to claim 1, wherein the priority determination unit is configured to determine the priorities with reference to at least one of the plurality of images included in the input data, the result of the normal estimation processing, and the result of the depth estimation processing.

3. The information processing apparatus according to claim 2, wherein the estimation unit comprises:
a first extraction unit configured to extract one or a plurality of first feature amounts from the plurality of images included in the input data;
a second extraction unit configured to extract one or a plurality of second feature amounts from depth information obtained from the input data; and
a normal/depth estimation unit configured to execute the normal estimation processing and the depth estimation processing with reference to the first feature amounts and the second feature amounts.

4. The information processing apparatus according to claim 3, wherein the second extraction unit comprises a depth information generation unit configured to generate the depth information from the plurality of images included in the input data.

5. The information processing apparatus according to claim 3, wherein
the input data includes a depth image, and
the second extraction unit is configured to extract the one or the plurality of second feature amounts from the depth image as the depth information.

6. The information processing apparatus according to claim 3, wherein the normal/depth estimation unit comprises:
a multi-attention processing unit configured to execute multi-attention processing with reference to the first feature amounts and the second feature amounts;
a normal estimation unit configured to execute the normal estimation processing with reference to a result of the multi-attention processing; and
a depth estimation unit configured to execute the depth estimation processing with reference to the result of the multi-attention processing.

7. The information processing apparatus according to claim 1, wherein the estimation unit is configured to execute the normal estimation processing and
the depth estimation processing using an estimation model, the information processing apparatus further comprising a learning unit configured to train the estimation model using a loss function according to the result of the normal estimation processing, the result of the depth estimation processing, and the priorities.

8. An information processing apparatus comprising:
an acquisition unit configured to acquire input data including a plurality of images under a plurality of illumination conditions;
an estimation unit configured to execute normal estimation processing and depth estimation processing using an estimation model with reference to the input data;
a priority determination unit configured to determine priorities of the normal estimation processing and the depth estimation processing; and
a learning unit configured to train the estimation model using a loss function according to a result of the normal estimation processing, a result of the depth estimation processing, and the priorities.

9. The information processing apparatus according to claim 8, wherein the priority determination unit is configured to determine the priorities with reference to at least one of the plurality of images included in the input data, the result of the normal estimation processing, and the result of the depth estimation processing.

10. The information processing apparatus according to claim 9, wherein the estimation unit comprises:
a first extraction unit configured to extract one or a plurality of first feature amounts from the plurality of images included in the input data;
a second extraction unit configured to extract one or a plurality of second feature amounts from depth information obtained from the input data; and
a normal/depth estimation unit configured to execute the normal estimation processing and the depth estimation processing with reference to the first feature amounts and the second feature amounts.

11. The information processing apparatus according to claim 10, wherein the second extraction unit comprises a depth information generation unit configured to generate the depth information from the plurality of images included in the input data.

12. The information processing apparatus according to claim 10, wherein
the input data includes a depth image, and
the second extraction unit is configured to extract the one or the plurality of second feature amounts from the depth image as the depth information.

13. The information processing apparatus according to claim 10, wherein the normal/depth estimation unit comprises:
a multi-attention processing unit configured to execute multi-attention processing with reference to the first feature amounts and the second feature amounts;
a normal estimation unit configured to execute the normal estimation processing with reference to a result of the multi-attention processing; and
a depth estimation unit configured to execute the depth estimation processing with reference to the result of the multi-attention processing.

14. An information processing method comprising:
acquiring input data including a plurality of images under a plurality of illumination conditions;
executing normal estimation processing and depth estimation processing with reference to the input data;
determining priorities of the normal estimation processing and the depth estimation processing; and
generating output data with reference to a result of the normal estimation processing, a result of the depth estimation processing, and the priorities.

15. The information processing method according to claim 14, wherein the determining the priorities comprises determining the priorities with reference to at least one of the plurality of images included in the input data, the result of the normal estimation processing, and the result of the depth estimation processing.

16. The information processing method according to claim 15, wherein the estimating comprises:
first extraction of extracting one or a plurality of first feature amounts from the plurality of images included in the input data;
second extraction of extracting one or a plurality of second feature amounts from depth information obtained from the input data; and
normal/depth estimation of executing the normal estimation processing and the depth estimation processing with reference to the first feature amounts and the second feature amounts.

17. The information processing method according to claim 16, wherein the second extraction comprises generating the depth information from the plurality of images included in the input data.

18. The information processing method according to claim 16, wherein
the input data includes a depth image, and
the second extraction comprises extracting the one or plurality of second feature amounts from the depth image as the depth information.

19. The information processing method according to claim 16, wherein the normal/depth estimation comprises:
executing multi-attention processing with reference to the first feature amounts and the second feature amounts;
executing the normal estimation processing with reference to a result of the multi-attention processing; and
executing the depth estimation processing with reference to the result of the multi-attention processing.

20. A non-transitory computer readable recording medium storing a program for causing a computer to function as the information processing apparatus according to claim 1, the program causing the computer to function as the acquisition unit, the estimation unit, the priority determination unit, and the generation unit.
